(19) United States
(12) Patent Application Publication
(10) Pub. No.: US 2008/0267450 A1
(43) Pub. Date: Oct. 30, 2008

(54) Position Tracking Device, Position Tracking Method, Position Tracking Program and Mixed Reality Providing System

(76) Inventors: Maki Sugimoto, Tokyo (JP); Akihiro Nakamura, Tokyo (JP); Hideaki Nii, Tokyo (JP); Masahiko Inami, Tokyo (JP)

Correspondence Address: William S. Frommer;Frommer Lawreance & Haug, 745 Fifth Avenue, New York, NY, 10151, US

(21) Appl. No.: 11/922,256

(22) PCT Filed: May 25, 2006
(86) PCT No.: PCT/JP2006/310950

§ 371 Date: Feb. 19, 2008

(30) Foreign Application Priority Data
Jun. 14, 2005 (JP) 2005-174257

(51) Int. Cl. G06K 9/78

(52) U.S. Cl. 382/103

(57) ABSTRACT

The present invention has a simpler structure than before and is designed to precisely detect the position of a real environment's target object on a screen. The present invention generates a special marker image MKZ including a plurality of areas whose brightness levels gradually change in X and Y directions, displays the special marker image MKZ on the screen of a liquid crystal display 2 such that the special marker image MKZ faces an automobile-shaped robot 3, detects, by using sensors SR1 to SR4 provided on the automobile-shaped robot 3 for detecting the change of brightness level of position tracking areas PD1A, PD2A, PD3 and PD4 of the special marker image MKZ in the X and Y directions, the change of brightness level, and then detects the position of the automobile-shaped robot 3 on the screen of the liquid crystal display 2 by calculating, based on the change of brightness level, the change of relative coordinate value between the special marker image MKZ and the automobile shaped robot 3.

### TECHNICAL FIELD

The present invention relates to a position tracking device, position tracking method, position tracking program and mixed reality providing system, and, for example, is preferably applied for detecting a target object of the real environment that is physically placed on a presentation image on a display and is preferably applied to a gaming device and the like that use that method of detection.

### BACKGROUND ART

Conventionally, there is a position tracking device that detects position by using an optical system, a magnetic sensor system, an ultrasonic sensor system and the like. Theoretically, if it uses an optical system, the measuring accuracy is determined by the pixel resolution of a camera and an angle between optical axes of the camera.

Accordingly, the position tracking device that includes the optical system uses brightness information and shape information of a marker at the same time in order to improve the accuracy of detection (see Patent Document 1, for example).

### Patent Document 1: Japanese Patent Publication No. 2003-103045

However, the above position tracking device that includes the optical system uses a camera, which requires more space than a measurement target does. In addition, the above position tracking device cannot measure a portion that is out of the scope of the camera. This limits a range the position tracking device can measure. There is still room for improvement.

On the other hand, a position tracking device that includes a magnetic sensor system is designed to produce a magnetostatic field inclined toward a measurement space in order to measure six degrees of freedom regarding the position and attitude of a sensor unit in the magnetostatic field. In this position tracking device, one sensor can measure six degrees of freedom. In addition, it performs a little or no arithmetic processing. Therefore, the position tracking device can measure it in real time.

Accordingly, the position tracking device that includes the magnetic sensor system can measure even if there is a shielding material that blocks light, compared to the position tracking device that includes the optical system. However, it is difficult for the position tracking device that includes the magnetic sensor system to increase the number of sensors that can measure at the same time. In addition, it is easily affected by a magnetic substance and a dielectric-substance in a measurement target space. Moreover, there are various problems: If there are plenty of metals in the measurement target space, this may dramatically decrease the accuracy of detection.

Moreover, a position tracking device that includes an ultrasonic sensor system has an ultrasonic transmitter attached to a measurement object and detects the position of the measurement object based on the distance between the transmitter and a receiver fixed in a space. On the other hand, there is another position tracking device that uses a gyro sensor and an acceleration meter in order to detect the attitude of the measurement object.

Since the position tracking device that includes the ultrasonic sensor system uses an ultrasonic wave, it works better than a camera even when there is a shielding material. However, if there is a shield material between the transmitter and the receiver, this may make it difficult for the position tracking device that includes the ultrasonic sensor system to measure.

### DISCLOSURE OF THE INVENTION

The present invention has been made in view of the above points and is intended to provide: a position tracking device, position tracking method and position tracking program that are simpler than the conventional ones but can accurately detect the position of a target object of the real environment on a screen or a display target; and a mixed reality providing system that uses the position tracking method.

To solve the above problem, a position tracking device, position tracking method and position tracking program of the present invention generates an index image including a plurality of areas whose brightness levels gradually change in a first direction (an X-axis direction) and a second direction (a Y-axis direction, which may be perpendicular to the X axis) on a display section, displays the index image on the display section such that the index image faces a mobile object, detects, by using a brightness level detection means provided on the mobile object for detecting the change of brightness level of the areas of the index image in the X and Y directions, the change of brightness level, and then detects the position of the mobile object on the display section by calculating, based on the change of brightness level, the change of relative coordinate value between the index image and the mobile object.

Therefore, the change of relative coordinate value between the index image and the mobile object can be calculated from the change of brightness level of the index image's areas where brightness level gradually changes when the mobile object moves on the display section. Based on the result of calculation, the position of the mobile object moving on the display section can be detected.

In addition, in a position tracking device of the present invention, the position tracking device for detecting the position of a mobile object moving on a display target includes: an index image generation means for generating an index image including a plurality of areas whose brightness levels gradually change in X and Y directions on the display target and displaying the index image on the top surface of the mobile object moving on the display target; a brightness level detection means provided on the top surface of the mobile object for detecting the change of brightness level of the areas of the index image in the X and Y directions; and a position detection means for detecting the position of the mobile object on the display target by calculating, based on the result of detection by the brightness level detection means, the change of relative coordinate value between the index image and the mobile object.

Therefore, the change of relative coordinate value between the index image and the mobile object can be calculated from the change of brightness level of the index image's areas where brightness level gradually changes when the mobile object, on which the index image is displayed, moves on the display target. Based on the result of calculation, the position of the mobile object moving-on the display target can be detected.

Moreover, in the present invention, a mixed reality providing system, which is for controlling an image that an information processing device displays on a screen of a display section and the movement of a mobile object in accordance with the mobile object placed on the screen in order to provide a sense of mixed reality in which the mobile object blends in with the image, includes the information processing device including: an index image generation means for generating an index image including a plurality of areas whose brightness levels gradually change in X and Y directions on the screen and displaying the index image as a part of the image on the display section such that the index image faces the mobile object; and an index image movement means for moving, in accordance with a predetermined movement command or a movement command input from a predetermined input means, the index image on the screen; and the mobile object including: a brightness level detection means provided on the mobile object for detecting the change of brightness level of the areas of the index image in the X and Y directions; a position detection means for detecting the current position of the mobile object on the display section by calculating, based on the change of brightness level detected by the brightness level detection means, the change of relative coordinate value between the index image and the mobile object, with respect to the index image moved by the index image movement means; and a movement control means for moving, in accordance with the index image, the mobile object such that the mobile object follows the index image in order to eliminate a difference between the current position of the mobile object and the position of the index image that has moved.

Therefore, in the mixed reality providing system, when the information processing device moves the index image, which is displayed on the screen of the display section, on the screen, the mobile object, which is placed on the screen of the display section, can be controlled to follow the index image. Accordingly, the mobile object can be indirectly controlled by the index image.

Furthermore, in the present invention, a mixed reality providing system, which is for controlling an image that an information processing device displays on a display target and the movement of a mobile object in accordance with the mobile object placed on the display target in order to provide a sense of mixed reality in which the mobile object blends in with the image, includes the information processing device including: an index image generation means for generating an index image including a plurality of areas whose brightness levels gradually change in X and Y directions on the display target and displaying the index image on the top surface of the mobile object moving on the display target; and an index image movement means for moving, in accordance with a predetermined movement command or a movement command input from a predetermined input means, the index image on the display target; and the mobile object including: a brightness level detection means provided on the top surface of the mobile object for detecting the change of brightness level of the areas of the index image in the X and Y directions; a position detection means for detecting the current position of the mobile object on the display target by calculating, based on the change of brightness level detected by the brightness level detection means, the change of relative coordinate value between the index image and the mobile object, with respect to the index image moved by the index image movement means; and a movement control means for moving, in accordance with the index image, the mobile object such that the mobile object follows the index image in order to eliminate a difference between the current position of the mobile object and the position of the index image that has moved.

Therefore, in the mixed reality providing system, when the information processing device moves the index image displayed on the top surface of the mobile object, the mobile object can be controlled to follow the index image. Accordingly, wherever the mobile object is placed and whatever the display target is, the mobile object can be indirectly controlled by the index image.

According to the present invention, the change of relative coordinate value between the index image and the mobile object can be calculated from the change of brightness level of the index image's areas where brightness level gradually changes when the mobile object moves on the display section. Accordingly, the position of the mobile object moving on the display section can be detected. This realizes a position tracking device, position tracking method and position tracking program that are simpler than the conventional ones but can accurately detect the position of a target object on a screen.

Moreover, according to the present invention, the change of relative coordinate value between the index image and the mobile object can be calculated from the change of brightness level of the index image's areas where brightness level gradually changes when the mobile object, on which the index image is displayed, moves on the display target. This can realize a position tracking device, position tracking method and position tracking program that can detect, based on the result of calculation, the position of the mobile object moving on the display target.

Furthermore, according to the present invention, when the information processing device moves the index image, which is displayed on the screen of the display section, on the screen, the mobile object, which is placed on the screen of the display section, can be controlled to follow the index image. This can realize a mixed reality providing system that can indirectly control the mobile object through the index image.

Furthermore, according to the present invention, when the information processing device moves the index image displayed on the top surface of the mobile object, the mobile object can be controlled to follow the index image. This can realize a mixed reality providing system that can indirectly control the mobile object through the index image, wherever the mobile object is placed and whatever the display target is.

### BRIEF DESCRIPTION OF THE DRAWINGS

FIG. 1 is a schematic diagram illustrating the principle of position detection by a position tracking device.

FIG. 2 is a schematic perspective view illustrating the configuration of an automobile-shaped robot (1).

FIG. 3 is a schematic diagram illustrating a basic marker image.

FIG. 4 is a schematic diagram illustrating a position tracking method and attitude detecting method using a basic marker image.

FIG. 5 is a schematic diagram illustrating a sampling rate of a sensor.

FIG. 6 is a schematic diagram illustrating a special marker image.

FIG. 7 is a schematic diagram illustrating the distribution of brightness level of a special marker image.

FIG. 8 is a schematic diagram illustrating a position tracking method and attitude detecting method using a special marker image.

FIG. 9 is a schematic diagram illustrating a target-object-centered mixed reality representation system.

FIG. 10 is a schematic block diagram illustrating the configuration of a computer device.

FIG. 11 is a sequence chart illustrating a sequence of a target-object-centered mixed reality representation process.

FIG. 12 is a schematic diagram illustrating a pseudo three-dimensional space where a real environment's target object blends in with a CG image of a virtual environment.

FIG. 13 is a schematic diagram illustrating a virtual-object-model-centered mixed reality representation system.

FIG. 14 is a sequence chart illustrating a sequence of a virtual-object-model-centered mixed reality representation process.

FIG. 15 is a schematic diagram illustrating a mixed reality representation system, as an alternative embodiment.

FIG. 16 is a schematic diagram illustrating a mixed reality representation system using a half mirror, as an alternative embodiment.

FIG. 17 is a schematic diagram illustrating how to control a real environment's target object, as an alternative embodiment.

FIG. 18 is a schematic diagram illustrating an upper-surface-radiation-type mixed reality providing device.

FIG. 19 is a schematic diagram illustrating a CG-image including a special marker image.

FIG. 20 is a schematic diagram illustrating the configuration of an automobile-shaped robot (2).

FIG. 21 is a schematic block diagram illustrating the circuit configuration of a note PC.

FIG. 22 is a schematic block diagram illustrating the configuration of an automobile-shaped robot.

FIG. 23 is a schematic diagram illustrating a special marker image when optically communicating.

FIG. 24 is a schematic diagram illustrating the operation of an arm section.

FIG. 25 is a schematic diagram illustrating an upper-surface-radiation-type mixed reality providing device.

FIG. 26 is a schematic perspective view illustrating applications.

FIG. 27 is a schematic diagram illustrating a marker image according to another embodiment.

### BEST MODE FOR CARRYING OUT THE INVENTION

An embodiment of the present invention will be described in detail with reference to the accompanying drawings.

### (1) Principle of Position Detection

### (1-1) Position Tracking Device

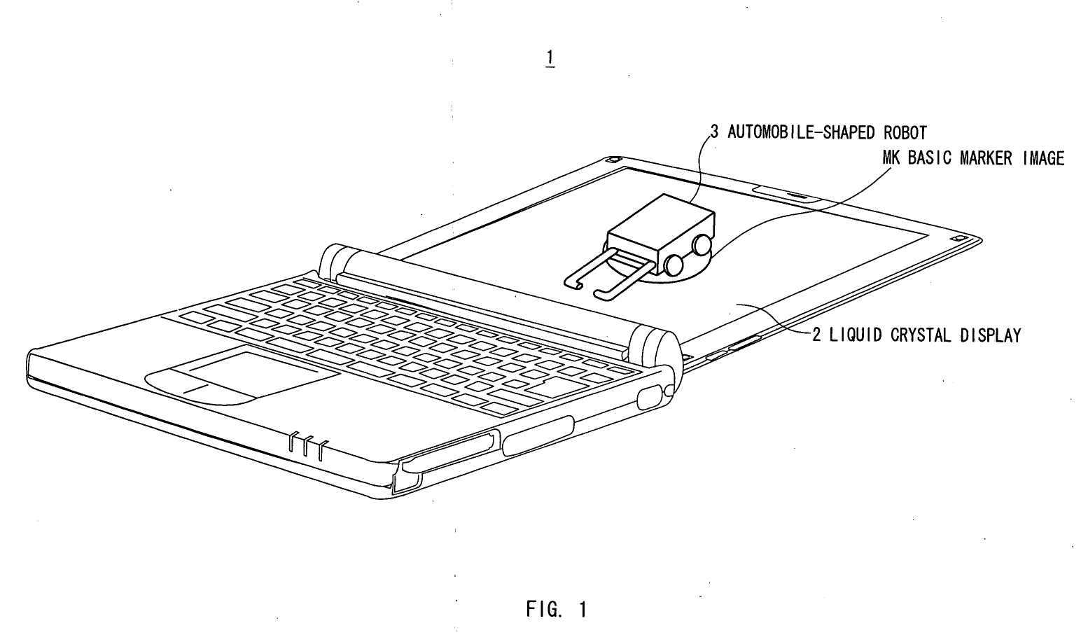

In the present embodiment, the following describes the principle of position detection upon which a position tracking device according to the present invention is based. As shown in FIG. 1, a notebook-type personal computer (also referred to as a “note PC”) 1, which is used as a position tracking device, is designed to display, in order to detect the change of position of an automobile-shaped robot 3 on a screen of a liquid crystal display 2, a basic maker image MK (described later) on the screen such that the basic marker image MK faces the automobile-shaped robot 3.

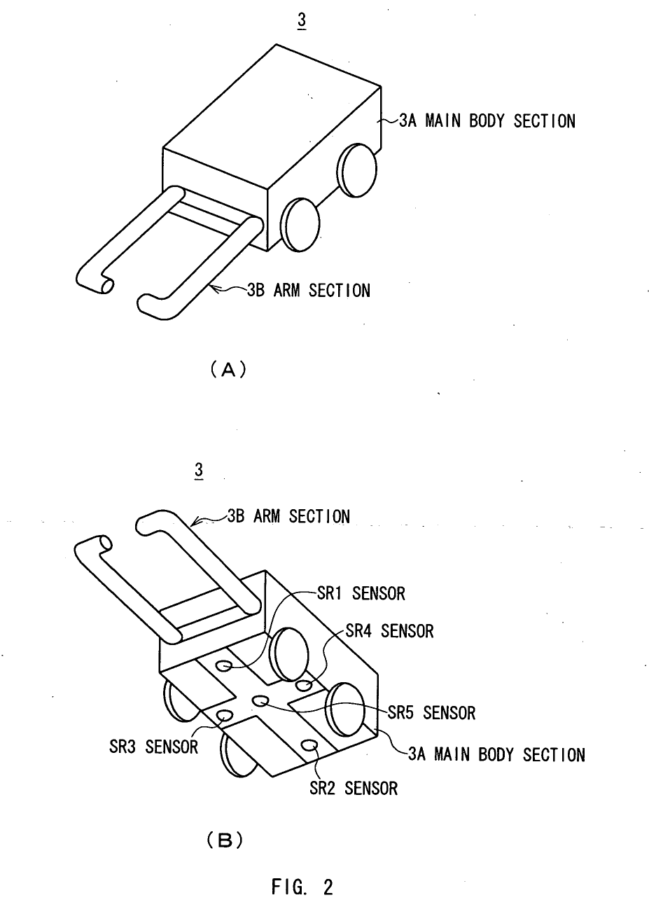

The automobile-shaped robot 3 includes, as shown in FIG. 2(A), four wheels on the left and right sides of a main body section 3A that is substantially in the shape of a rectangular parallelepiped. The automobile-shaped robot 3 also includes an arm section 3B on the front side to grab an object. The automobile-shaped robot 3 is operated wirelessly by an external remote controller (not shown) and moves on the screen of the liquid crystal display 2.

In addition, the automobile-shaped robot 3 includes, as shown in FIG. 2(B), five sensors, or phototransistors, SR1 to SR5 on the predetermined positions of the bottom side of the robot 3, which may face the basic marker image MK (FIG. 1) on the screen of the liquid crystal display 2. The sensors SR1 and SR2 are placed on the front and rear sides of the main body section 3A, respectively. The sensors SR3 and SR4 are placed on the left and right sides of the main body section 3A, respectively. The sensor SR5 is substantially placed on the center of the main body section 3A.

The note PC 1 (FIG. 1) receives, in accordance with a predetermined position tracking program, from the automobile-shaped robot 3 through wired or wireless connections brightness level data of the basic marker image MK received by the sensors SR1 to SR5 of the automobile-shaped robot 3 and calculates, in accordance with the brightness level data, the change of position of the automobile-shaped-robot 3 on the screen and then detects the current position and direction (attitude) of the automobile-shaped robot 3.

### (1-2) Position Tracking Method with the Basic Maker Image

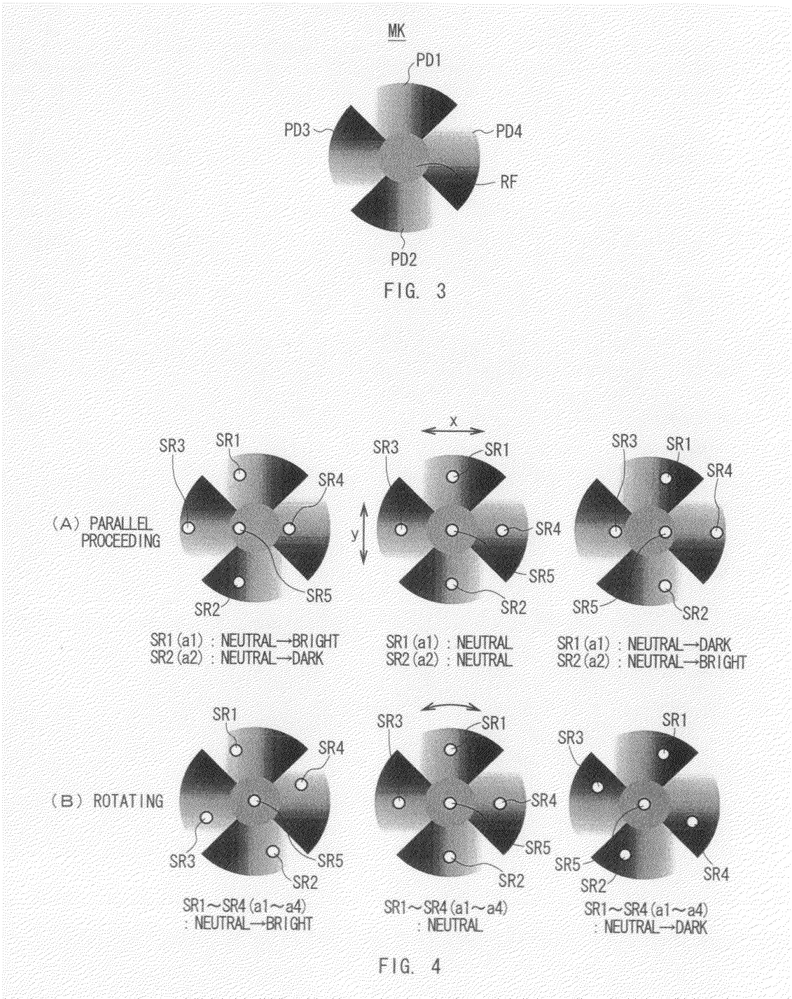

As shown in FIG. 3, the basic maker image MK includes: position tracking areas PD1 to PD4, each of which is substantially in the shape of a sector whose center angle is 90 degrees and is starting from a boundary line tilted at an angle of 45 degrees from the horizontal or vertical directions; and a reference area RF, which is substantially in the shape of a circle on the center of the basic maker image MK.

The position tracking areas PD1 to PD4 are gradated: The brightness levels in the areas linearly change from 0 to 100%. In this case, the brightness levels of the position tracking areas PD1 to PD4 change from 0 to 100% in anticlockwise direction. However, the position tracking areas PD1 to PD4 are not limited to this: Instead, the brightness levels of the position tracking areas PD1 to PD4 may change from 0 to 100% in clockwise direction.

By the way, all the brightness levels of the position tracking areas PD1 to PD4 of the basic marker image MK may not be linearly gradated from 0 to 100%. Alternatively, they may be gradated nonlinearly such that they for example form an S-shaped curve.

The brightness level of the reference area RF is fixed at 50%, which is different from that of the position tracking areas PD1 to PD4. The reference area RF serves as a reference area of brightness level in order to eliminate the effect of ambient and disturbance light when the note PC1 is calculating the position of the automobile-shaped robot 3.

The fact is that: The basic marker image MK is first displayed on the liquid crystal display 2 as shown in the center of FIG. 4(A) such that the sensors SR1 to SR5 attached to the bottom of the automobile-shaped robot 3 are substantially aligned with the centers of the position tracking areas PD1 to PD4 and reference area RF of the basic marker image MK and that they become a neutral state in which all the brightness levels are set at 50%; and, when the automobile-shaped robot 3 moves along a X axis toward the right, the brightness level a1 of the sensor SR1 changes, as shown in the right of FIG. 4(A), from the neutral state to a dark state while the brightness level a2 of the sensor SR2 changes from the neutral state to a bright state.

Similarly, when the automobile-shaped robot 3 moves along the X axis toward the left, the brightness level a1 of the sensor SR1 changes, as shown in the left of FIG. 4(A), from the neutral state to a bright state while the brightness level a2 of the sensor SR2 changes from the neutral state to a dark state. On the other hand, the brightness levels a3, a4 and a5 of the sensors SR3, SR4 and SR5 remain unchanged.

Accordingly, by referring to the brightness levels a1 and a2 of the sensors SR1 and SR2, which are supplied from the automobile-shaped robot 3, the note PC 1 can calculate a difference dk in X direction as follows:

dx=p1(a2−a1). (1)

wherein p1 is a proportionality factor, which can dynamically change according to ambient light in a position detection space or calibration. By the way, as shown in the center of FIG. 4(A), if there is no difference in X direction, then “(a2−a1)” of the equation (1) becomes zero and therefore the difference dx becomes zero.

Similarly, by referring to the brightness levels a3 and a4 of the sensors SR3 and SR4, which are supplied from the automobile-shaped robot 3, the note PC 1 can calculate a difference dy in Y direction as follows:

dy=p2(a4−a3) (2)

wherein p2 is, like P1, a proportionality factor, which can dynamically change according to ambient light in a position detection space or calibration. By the way, if there is no difference in Y direction, then “(a4−a3)” of the equation (2) becomes zero and therefore the difference dy becomes zero.

On the other hand, as shown in the center of FIG. 4(B), the basic marker image MK is first displayed on the liquid crystal display 2 such that the sensors SR1 to SR5 attached to the bottom of the automobile-shaped robot 3 are substantially aligned with the centers of the position tracking areas PD1 to PD4 and reference area RF of the basic marker image MK and that they become a neutral state in which all the brightness-levels are set at 50%; and, when the automobile-shaped robot 3 rotates around the basic marker image MK in clockwise with its center axis kept at the same place, the brightness levels a1, a2, a3 and a4 of the sensor SR1, SR2, SR3 and SR4 change, as shown in the right of FIG. 4(B), from the neutral state to a dark state. By the way, the brightness level a5 of the sensor SR5 remains unchanged.

Similarly, when the automobile-shaped robot 3 rotates around the basic marker image MK in anticlockwise with its center axis kept at the same place, the brightness levels a1, a2, a3 and a4 of the sensor SR1, SR2, SR3 and SR4 change, as shown in the left of FIG. 4(B), from the neutral state to a bright state. By the way, the brightness level a5 of the sensor SR5 remains unchanged.

Accordingly, by referring to the brightness levels a1 to a4 of the sensors SR1 to SR4 and the brightness level a5 of the sensor SR5 corresponding to the reference area RF, which are supplied from the automobile-shaped robot 3, the note PC 1 can calculate a pivot angle θ of the automobile-shaped robot 3 as follows:

sin θ=p3((a1+a2+a3+a4)−4×(a5)) (3)

In the equation (3), the brightness level a5 of the reference area RF is multiplied by four before subtraction. This allows calculating a precise pivot angle θ by eliminating the effect of ambient light other than the basic marker image MK.

In that case, p3 is a proportionality factor, which can dynamically change according to ambient light in a position detection space or calibration. By the way, if the automobile-shaped robot 3 does not rotate in clockwise or anticlockwise, then “((a1+a2+a3+a4)−4×(a5))” of the equation (3) becomes zero and therefore the pivot angle θ of the automobile-shaped robot 3 becomes zero.

By the way, the note-PC 1 can calculate the differences dx and dy and the pivot angle θ of the automobile-shaped robot 3 separately and at the same time. Therefore, even if the automobile-shaped robot 3 moving to the right rotates in anticlockwise, the note PC 1 can calculate the current position and direction (attitude) of the automobile-shaped robot 3.

Moreover, if the main body section 3A of the automobile-shaped robot 3 placed on the screen of the liquid crystal display 2 is equipped with a mechanism that lifts it up and down, the note PC 1 is designed to detect the height Z of the main body section 3A as follows:

Z=p4×√(a1+a2+a3+a4). (4)

wherein p4 is a proportionality factor, which can dynamically change according to ambient light in a position detection space or calibration.

That is, as the height Z of the automobile-shaped robot 3 changes, all the brightness levels a1 to a4 of the sensors SR1 to SR4 change. This allows calculating the height Z of the automobile-shaped robot 3 by the equation (4). By the way, the equation (4) uses a square root because, in the case of a point light source, the brightness level drops at the rate of distance squared.

In that manner, the note PC1 detects, based on the differences dx and dy and pivot angle θ of the automobile-shaped robot 3 moving on the screen of the liquid crystal display 2, the current position and attitude of the automobile-shaped robot 3 and then moves, in accordance with a difference between the previous and current positions, the basic maker image MK such that the basic maker image MK is beneath the bottom face of the automobile-shaped robot 3. Accordingly, if the automobile-shaped robot 3 moves on the screen of the liquid crystal display 2, the basic maker image MK can always follow the automobile-shaped robot 3, enabling the detection of current position and attitude.

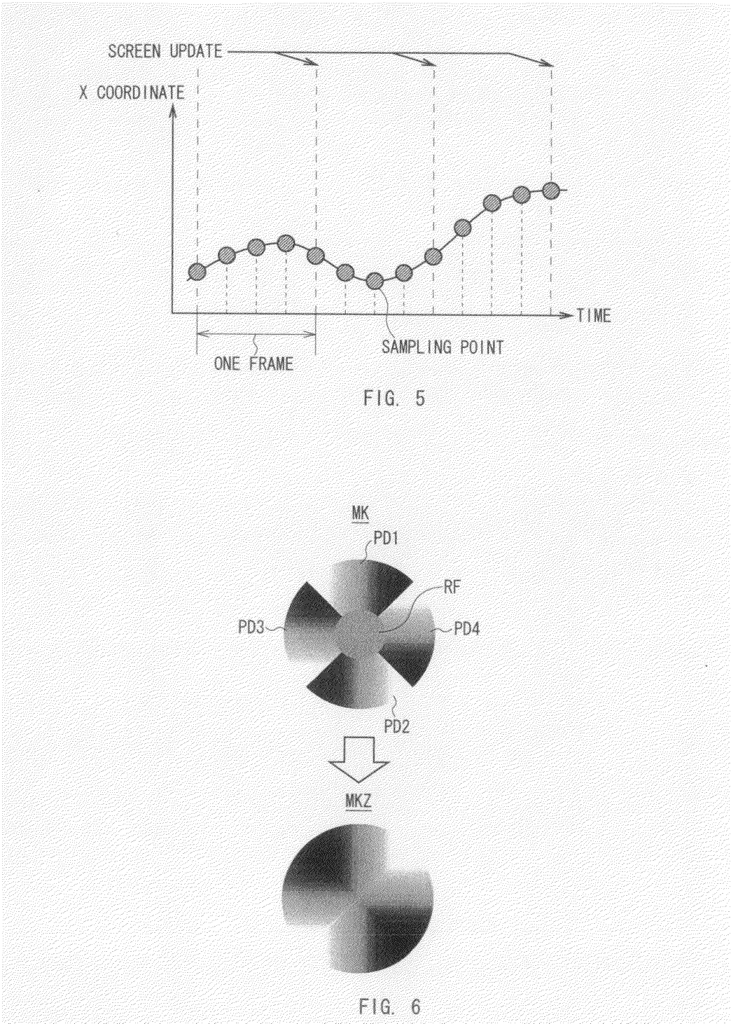

By the way, in the note PC1, as shown in FIG. 5, the sampling frequency for the brightness levels a1 to a5 of the sensors SR1 to SR5 is greater than the frame frequency or field frequency for displaying the basic marker image MK on the screen of the liquid crystal display 2. Accordingly, the note PC 1 can calculate the current position and attitude of the automobile-shaped robot 3 at high speed without depending on the frame frequency or the field frequency.

In fact, if the frame frequency is X (=30) [Hz], the automobile-shaped robot 3 is moving on the screen of the liquid crystal display 2 even during the period of 1/X seconds when the screen is being updated. Even if that is the case, because the sampling frequency ΔD of the sensors SR1 to SR5 is greater than the frame frequency X [Hz], a followable speed V for detecting the position is represented as follows:

V=X+ΔD (5)

Even if the automobile-shaped robot 3 is moving at high speed, the note PC1 can precisely calculate the current position without depending on the frame frequency or the field frequency.

### (1-3) Position Tracking Method with a Special Marker Image

In the above position tracking method that uses the basic marker image MK, if the automobile-shaped robot 3 moves from the neutral state and rotates in clockwise or anticlockwise at high speed, and the sensors SR1, SR2, SR3 and SR4 overruns the position tracking areas PD1 to PD4, the pivot angle θ may be wrongly calculated as −44 degrees instead of +46 degrees and the basic maker image MK may be corrected, with respect to the automobile-shaped robot 3, in the opposite direction instead of being returned to the neutral state.

In addition, in the basic marker image MK, the brightness levels around the boundaries between the position tracking areas PD1 to PD4 dramatically increase from 0 to 100% or decrease from 100 to 0%. This could be the cause of wrong detection due to the leak of the 100%-brightness-level light into the 0%-brightness-level light area.

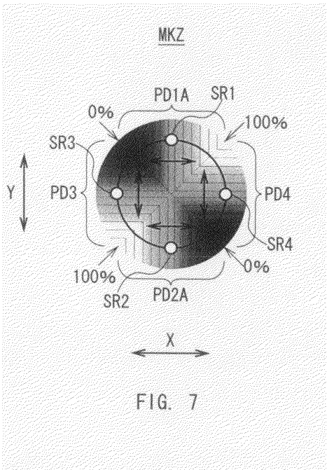

Accordingly, as shown in FIG. 6, the note PC 1 uses a special marker image MKZ, which is one step ahead of the basic marker image MK. The special marker image MKZ includes, as shown in FIG. 7, the position tracking areas PD3 and PD4, which are the same as those of the basic maker image MK (FIG. 6). The special marker image MKZ includes position tracking areas PD1A and PD2A, whose brightness levels are linearly gradated from 0 to 100% in clockwise while the position tracking areas PD1 and PD2 of the basic marker image MK are gradated in anticlockwise.

Accordingly, the special marker image MKZ does not have a portion in which the brightness level dramatically change from 0 to 100%, which is different from the basic marker image MK. This prevents the leak of the 100%-brightness-level light into the 0%-brightness-level light area, unlike the basic marker image MK.

In addition, the brightness levels a1, a2, a3 and a4 of the special marker image MKZ linearly change, in accordance with how the automobile-shaped robot 3 moves, within the range of 0 to 100% along X and Y axes, along which the sensors SR1, SR2, SR3 and SR4 move within the position tracking areas PD1A, PD2A, PD3 and PD4.

Furthermore, the brightness levels a1, a2, a3 and a4 of the special marker image MKZ linearly change, in accordance with how the automobile-shaped robot 3 rotates, from 0% to 100% to 0% to 100% to 0% in the range of 360 degrees in the circumferential direction, along which the sensors SR1, SR2, SR3 and SR4 move within the position tracking areas PD1A, PD2A, PD3 and PD4.

By the way, all the brightness levels of the position tracking areas PD1A, PD2A, PD3 and PD4 of the special marker image MKZ may not be linearly gradated from 0 to 100%. Alternatively, they may be gradated nonlinearly such that they for example form an S-shaped curve.

In addition, in the special marker image MKZ, even if the automobile-shaped robot 3 moves from the neutral state and rotates, and the sensors SR1, SR2, SR3 and SR4 overruns the position tracking areas PD1A, PD2A, PD3 and PD4, what it causes is, at most, a little error such as calculating the pivot angle θ as +44 degrees instead of +46 degrees. That reduces, compared to the basic marker image MK, detection errors, improving the capability of following the automobile-shaped robot 3.

In that manner, when the special marker image MKZ, which is a certain distance away from the automobile-shaped robot 3 moved, is returned to the neutral state by being moved to under the automobile-shaped robot 3 such that the special marker image MKZ faces the sensors SR1 to SR5 on the bottom face of the automobile-shaped robot 3, the note PC 1 can prevent the special marker image MKZ from moving in the opposite direction due to the symbol error, which is something that the basic marker image MK might do.

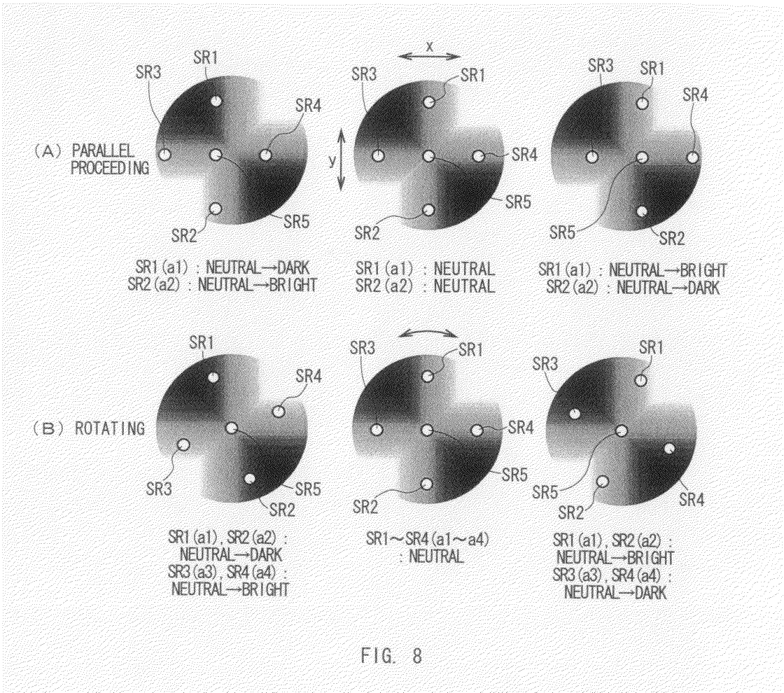

In fact, when the automobile-shaped robot 3 moves from the neutral state to the right, the brightness level a1 of the sensor SR1 changes, as shown in the right of FIG. 8(A), from the neutral state to a bright state while the brightness level a2 of the sensor SR2 changes from the neutral state to a dark state.

On the other hand, when the automobile-shaped robot 3 moves from the neutral state to the left, the brightness level a1 of the “sensor SR1 changes, as shown in the left of FIG. 8(A), from the neutral state to a dark state while the brightness level a2 of the sensor SR2 changes from the neutral state to a bright state. In this case, the brightness levels a3, a4, and a5 of the sensors SR3, SR4 and SR5 remain unchanged.

Accordingly, by referring to the brightness levels a1 and a2 of the sensors SR1 and SR2, which are supplied from the automobile-shaped robot 3, the note PC 1 can calculate, in accordance with the above equation (1), a difference dx in X direction.

Similarly, by referring to the brightness levels a3 and a4 of the sensors SR3 and SR4, which are supplied from the automobile-shaped robot 3, the note PC 1 can calculate, in accordance with the above equation (2), a difference dy in Y direction.

On the other hands as shown in the center of FIG. 8(B), the special marker image MKZ is first displayed on the liquid crystal display 2 such that the sensors SR1 to SR4 attached to the bottom of the automobile-shaped robot 3 are substantially-aligned with the centers of the position tracking areas PD1A, PD2A, PD3 and PD4 of the special marker image MKZ and that they become a neutral state in which all the brightness levels are set at 50%; and, when the automobile-shaped robot 3 moves from the neutral state and rotates around the special marker image MKZ in clockwise with its center axis kept at the same place, the brightness levels a1 and a2 of the sensors SR1 and SR2 change, as shown in the right of FIG. 8(B), from the neutral state to a bright state while the brightness levels a3 and a4 of the sensors SR3 and SR4 change from the neutral state to a dark state.

Similarly, when the automobile-shaped robot 3 moves from the neutral state and rotates around the special marker image MKZ in anticlockwise with its center axis kept at the same place, the brightness levels a1 and a2 of the sensors SR1 and SR2 change, as shown in the left of FIG. 8(B), from the neutral state to a dark state while the brightness levels a3 and a4 of the sensors SR3 and SR4 change from the neutral state to a bright state.

Accordingly, by referring to the brightness levels a1 to a4 of the sensors SR1 to SR4, which are supplied from the automobile-shaped robot 3, the note PC 1 can calculate a pivot angle dB as follows:

sin dθ=p6((a3+a4)−(a1+a2)) (6)

wherein p6 is a proportionality factor, which can dynamically change according to ambient light in a position detection space or calibration. That is, when it does not rotate, “((a3+a4)−(a1+a2))” of the equation (6) is zero and therefore the pivot angle dθ is zero. In the equation (6), from the sign of “((a3+a4)−(a1+a2))”, it can determine whether it rotates in clockwise or anticlockwise.

In this case, compared to the equation (3) for the basic marker image MK, the equation (6) for the special marker image MKZ performs a subtraction process such as “((a3+a4)−(a1+a2))”. Therefore, it does not have to use the brightness level a5 corresponding to the reference RF of the basic marker image MK. Accordingly, in the basic marker image MK, if the sensor SR5 uniquely causes an error about the brightness level a5, this error gets quadrupled. However, this does not occur to the special marker image MKZ.

In addition, if the note PC 1 uses the equation (6) for the special marker image MKZ, instead of the equation (3) for the basic marker image MK that adds up all the brightness levels a1, a2, a3 and a4, the note PC1 performs a subtraction process such as “((a3+a4)−(a1+a2))” of the equation (6). Accordingly, even if there are homogeneously-generated errors over all the brightness levels a1, a2, a3 and a4 due to disturbance light and the like, the subtraction process can compensate for that. Thus, the note PC 1 can precisely detect the pivot angle dθ by using a simple calculation formula.

By the way, the note PC1 can separately calculate the differences dx and dy and pivot angle dθ of the automobile-shaped robot 3 at the same time. Accordingly, even if the automobile-shaped robot 3 moving to the right rotates in anticlockwise, the note PC1 can calculate the current position and direction (attitude) of the automobile-shaped robot 3.

Moreover, if the main body section 3A of the automobile-shaped robot 3 placed on the screen of the liquid crystal display 2 is equipped with a mechanism that lifts it up and down, the note PC 1 that uses the special marker image MKZ can detect the height Z of the main body section in the same way as when it uses the basic marker image MK, in accordance with the above equation (4).

In that manner, the note PC1 detects, based on the differences dx and dy and pivot angle dθ of the automobile-shaped robot 3 moving on the screen of the liquid crystal display 2, the current position and attitude of the automobile-shaped robot 3 and then moves, in accordance with a difference between the previous and current positions, the special maker image MKZ such that the special maker image MKZ is beneath the bottom face of the automobile-shaped robot 3. Accordingly, if the automobile-shaped robot 3 moves on the screen of the liquid crystal display 2, the special maker image MKZ can always follow the automobile-shaped robot 3, enabling the continuous detection of current position in real time.

By the way, in the note PC1, the sampling frequency for the brightness levels of the sensors SR1 to SR4 is greater than the frame frequency or field frequency for displaying the special marker image MKZ on the screen of the liquid crystal display 2. Accordingly, the note PC 1 can detect the current position and attitude of the automobile-shaped robot 3 at high speed without depending on the frame frequency or the field frequency.

Following describes a mixed reality providing system, which is based on the above-noted basic idea of position-detection principle. Before that, the basic concept of a mixed reality representation system will be described: In the mixed reality representation system, when a physical target object of the real environment, or the automobile-shaped robot 3 placed on the screen of the liquid crystal display 2, moves on a screen, a background image on the screen moves in conjunction with the motion of the target object, or an additional image of a virtual object model is generated and displayed on the screen in accordance with the motion of the target object.

### (2) Basic Concept of the Mixed reality Representation System

Basically, there are two basic ideas about the mixed reality representation system: The first is a target-object-centered mixed reality representation system, in which, when a user moves the target object of the real environment placed on an image displayed on a display means such as a liquid crystal display or screen, a background image moves in conjunction with the motion of the target object, or an additional image of a virtual object model is generated and displayed in accordance with the motion of the target object.

The second is a virtual-object-model-centered mixed reality representation system, in which, when a target object model of a virtual environment, which corresponds to a target object of the real environment placed on an image displayed on a display means such as a liquid crystal display, moves in a computer, the target object of the real environment moves in conjunction with the motion of the target object model of the virtual environment, or an additional image of a virtual object model to be added is generated and displayed in accordance with the motion of the target object model of the virtual environment.

The following describes the target-object-centered mixed reality representation system and the virtual-object-model-centered mixed reality representation system in detail.

### (2-1) Overall Configuration of the Target-Object-Centered Mixed Reality Representation System

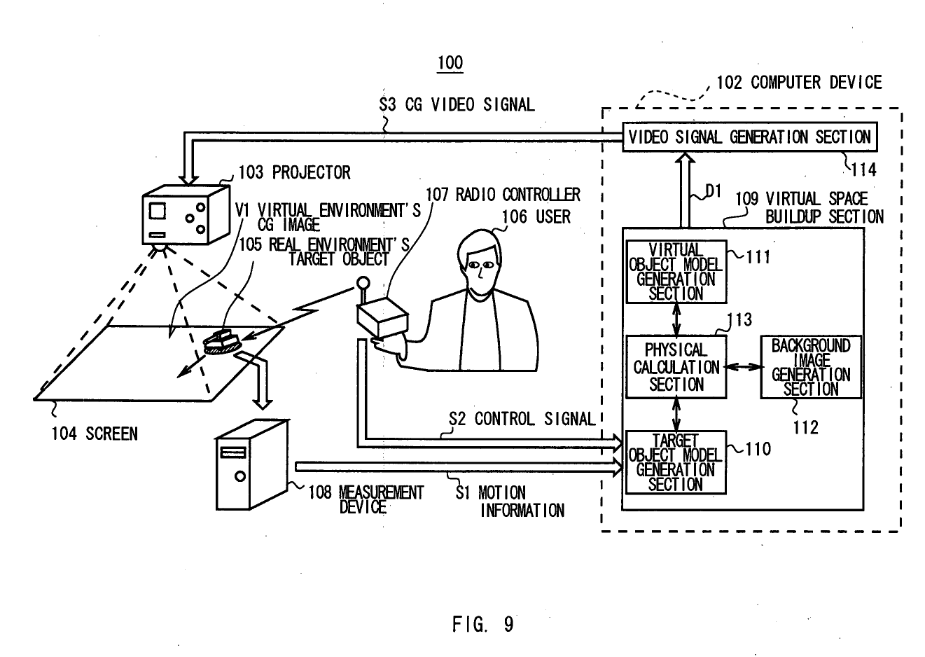

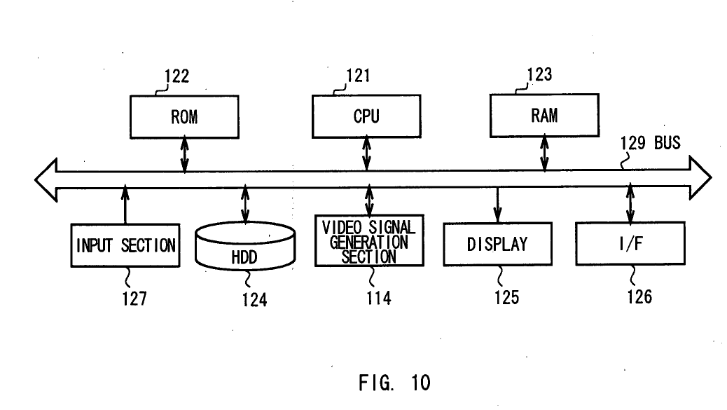

In FIG. 9, the reference numeral 100 denotes a target-object-centered mixed reality representation system that project a virtual environment's computer graphics (CG) image V1, which is supplied from a computer device 102, on a screen 104 through a projector 103.

On the screen 104 where the virtual environment's CG image V1 is projected, a target object 105 of the real environment, or a model combat vehicle remote-controlled by a user 106 through a radio controller 107, is placed. The target object 105 of the real environment is placed upon the CG image V1 on the screen 104.

The target object 105 of the real environment is controlled by the user 106 through the radio controller 107 and moves on the screen 104. At that time, the mixed reality representation system 100 acquires through a magnetic or optical measurement device 108 motion information S1 that indicates the two-dimensional position and three-dimensional attitude (or motion) of the target object 105 of the real environment on the screen 104 and then supplies the motion information S1 to a virtual space buildup section 109 of the computer device 102.

In addition, when a user 106 inputs through the radio controller 107 a command, such as emitting a laser beam or launching a missile from the target object 105 of the real environment to the virtual environment's CG image V1, or setting a barrier, or placing mines or the like, the radio controller 107 supplies, in accordance with the command, a control signal S2 to the virtual space buildup section 109 of the computer device 102.

The virtual space buildup section 109 includes: a target object model generation section 110 that generates on the computer device 102 a virtual environment's target object model corresponding to the real environment's target object 105 moving around on the screen 104; a virtual object model generation section 111 that generates, in accordance with the control signal S2 from the radio controller 107, a virtual object model (such as missiles, laser beams, barriers, mines or the like) to be added through the virtual environment's CG image V1 to the real environment's target object 105; a background image generation section 112 that generates a background image to be displayed on the screen 104; and a physical calculation section 113 that performs various physical calculation processes, such as changing a background image in accordance with the target object 105 radio-controlled by the user 106 or adding a virtual object model in accordance with the motion of the target object 105.

Accordingly, the virtual space buildup section 109 uses the physical calculation section 113 and moves, in accordance with the motion information S1 directly acquired from the real environment's target object 105, a virtual environment's target object model in the world of information generated by the computer device 102. In addition, the virtual space buildup section 109 supplies to a video signal generation section 114 data D1 that indicates a background image, which has been changed in accordance with the motion, a virtual object model, which will be added to the target object model, and the like.

The content of the background image to be displayed is considered to be an arrow mark that indicates which direction the real environment's target object 105 is headed and a scenic image that varies according to the motion of the real environment's target object 105 on the screen.

The video signal generation section 114 generates, based on the data D1 such as background images and virtual object models, a CG video signal S3 to have a background image changing with the real environment's target object 105 and to add a virtual object model and then projects, in accordance with the CG video signal S3, the virtual environment's CG image V1 on the screen 104 through the projector 103. This gives a user a sense of mixed reality through a pseudo three-dimensional space generated by combining the virtual environment's CG image V1 and the real environment's target object 105 on the screen 104.

By the way, the video signal generation section 114 cuts off, in order to prevent a part of the CG image V1 from being projected on the surface of the real environment's target object 105 when the virtual environment's image V1 is projected on the screen 104, a part of the image equivalent to the real environment's target object 105 in accordance with the position and size of the target object model corresponding to the target object 105, and generates the CG video signal S3 such that a shadow is added to around the target object 105.

By the way, the mixed reality representation system 100 can provide a pseudo three-dimensional space generated by combining the virtual environment's CG image V1 projected from the projector 103 onto the screen 104 and the real environment's target object 105 to all the users 106 who can see the screen 104 with the naked eye.

In that sense, the target-object-centered mixed reality representation system 100 may be categorized as the so-called optical see-through type, in which light reach the user 106 directly from the outside, rather than the so-called video see-through type.

### (2-1-1) Configuration of the Computer Device

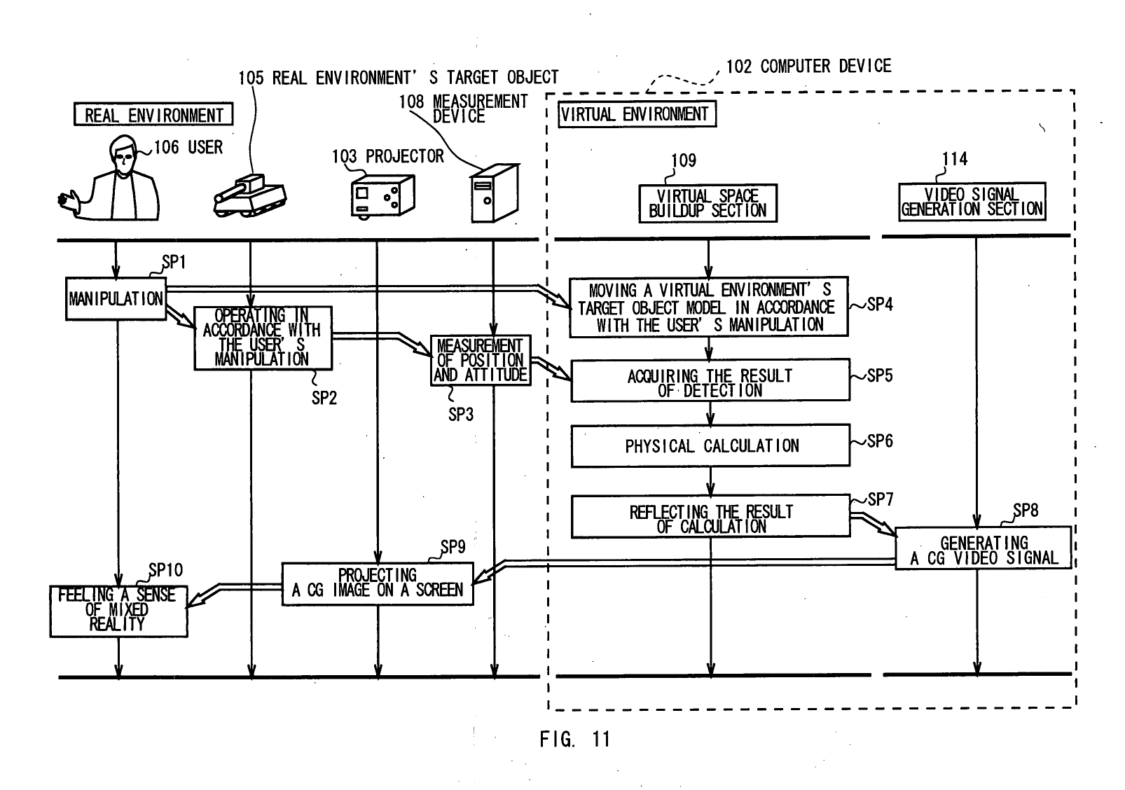

In order to realize such a target-object-centered mixed reality representation system 100, the computer device 102 includes, as shown in FIG. 10, a CPU (Central Processing Unit) 121 that takes overall control and is connected via a bus 129 to a ROM (Read Only Memory) 122, a RAM (Random Access Memory) 123, a hard disk drive 124, a video signal generation section 114, a display 125 equivalent to an LCD (Liquid Crystal Display), an interface 126, which receives the motion information S1 and the control signal S2 and supplies a motion command that moves the real environment's target object 105, and an input section 127, such as a keyboard. In accordance with a basic program and mixed reality representation program loaded onto RAM 123 from the hard disk drive 124, the CPU 121 performs a predetermined process to realize the virtual space buildup section 109 as a software component.

### (2-1-2) Sequence of Target-Object-Centered Mixed Reality Representation Process

Following describes a sequence of a target-object-centered mixed reality representation process by which the virtual environment's CG image V1 is changed, in the target-object-centered mixed reality representation system 100, in accordance with the motion of the real environment's target object 105.

As shown in FIG. 11, the sequence of the target-object-centered mixed reality representation process can be divided into a process flow for the real environment and a process flow for the virtual environment controlled by the computer-device 102. The results of each process are combined on the screen 104.

Specifically, the user 106 at step SP1 manipulates the radio controller 107 and then proceeds to next step SP2. In this case, the user 106 inputs a command, for example, in order to move the real environment's target object 105 on the screen 104 or to add a virtual object model, such as missiles or laser beams, to the real environment's target object 105.

The real environment's target object 105 at step SP2 actually performs an action on the screen 104 in accordance with the command from the radio controller 107. At this time, the measurement device 108 at step SP3 measures the two-dimensional position and three-dimensional attitude of the real environment's target object 105 moving on the screen 104 and then supplies to the virtual space buildup section 109 the motion information S1 as the result of measurement.

On the other hand, the virtual space buildup section 109 at step SP4 controls, if the control signal S2 (FIG. 9) that was supplied from the radio controller 107 after the user 106 manipulated the radio controller 107 is a signal indicating the two-dimensional position on the screen 104, the virtual object model generation section 111 in accordance with the control signal S2 in order to create a virtual environment's target object and then-moves it in a virtual space in a two-dimensional way.

In addition, the virtual space buildup section 109 at step SP4 controls, if the control signal S2 that was supplied after the radio controller 107 was manipulated is a signal indicating the three-dimensional attitude (motion), the virtual object model generation section 111 in accordance with the control signal S2 in order to create a virtual environment's target object and then moves it in a virtual space in a three-dimensional way.

Subsequently, the virtual space buildup section 109 at step SP5 acquires the motion information S1 through the physical calculation section 113 from the measurement device 108 and, at step SP6, calculates, based on the motion information S1, the data D1 such as a background image, on which the virtual environment's target object model moves, and a virtual object model added to the target object model.

Subsequently, the virtual space buildup section 109 at step SP7 performs a signal process to the data D1, or the result of calculation by the physical calculation section 113, in order for the data D1 to be reflected in the virtual environment's CG image V1. As a result of the reflection process at step SP7, the video signal generation section 114 of the computer device 102 at step SP8 produces the CG video signal S3 such that it is associated with the motion of the real environment's target object 105 and then outputs the CG video signal S3 to the projector 103.

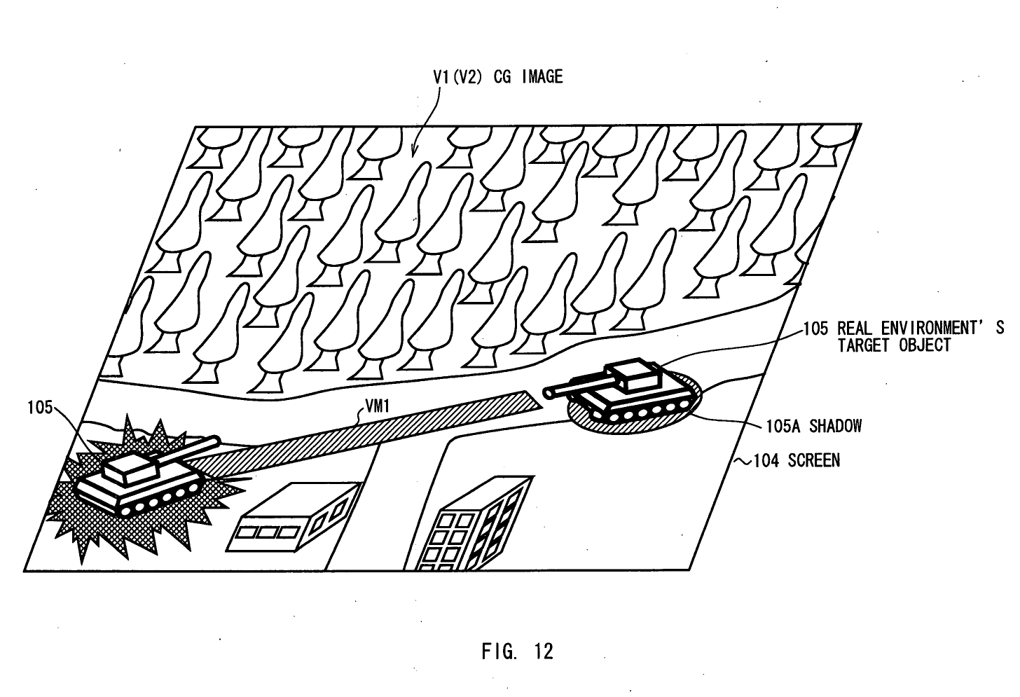

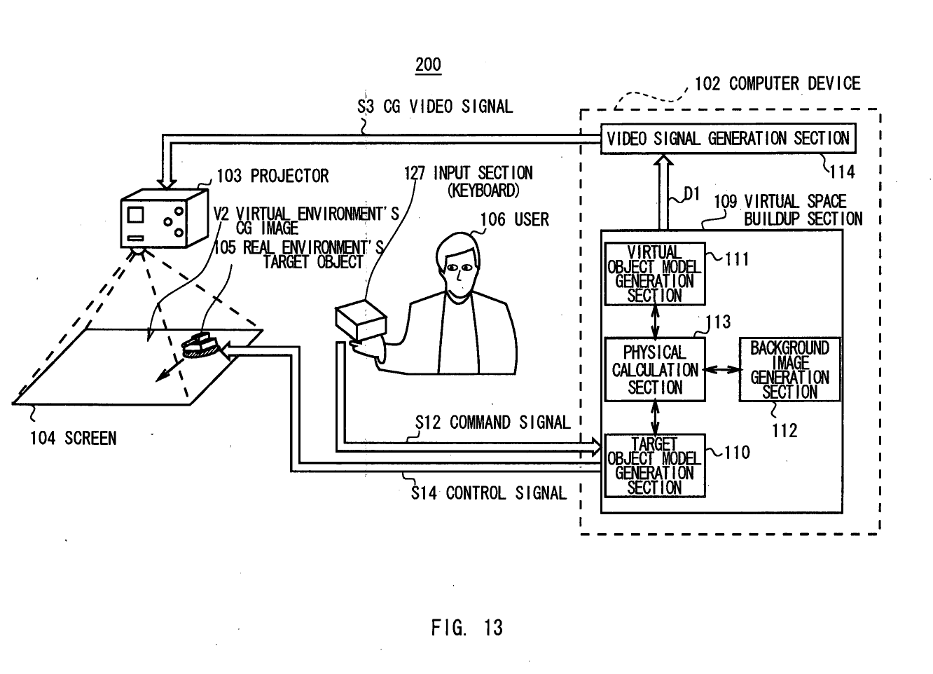

The projector 103 at step SP9 projects, in accordance with the CG video signal S3, the virtual environment's CG image V1, as shown in FIG. 12, on the screen 104. This virtual environment's CG image V1, which is an image when the user 106 remote-controlled the real environment's target object 105, appears to have a background image, such as forests or buildings, blended with the real environment's target object 105, representing a moment when a virtual object model VM1, such as a laser beam, is added from the right-hand real environment's target object 105 to the left-hand real environment's object 105 remote-controlled by the other user.

Accordingly, the projector 103 projects on the screen 104 the virtual environment's CG image V1 in which a background image and a virtual object model change with the real environment's target object 105 remote-controlled by the user 106, such that the real environment's target object 105 and the virtual environment's CG image V1 overlap with one another. In this manner, the real environment's target object 105 blends in with the virtual environment's CG image V1 on the screen 104 without giving a user a sense of discomfort.

In this case, that prevents a part of the virtual environment's CG image V1 from being projected on the surface of the real environment's target object 105 when the virtual environment's CG image V1 is projected on the screen 104. At the same time, a shadow 105A, as an image, is added to around the real environment's target object 105. This presents a pseudo three-dimensional space with a more vivid sense of reality by combining the real environment's target object 105 with the virtual environment's CG image V1.

Accordingly, the user 106 at step SP10 (FIG. 11) watches the pseudo three-dimensional space, in which the real environment's target object 105 blends in with the virtual environment's CG image V1, on the screen 104 and therefore can feel a more vivid sense of mixed reality with the more expanded functions.

### (2-1-3) Operation and Effect in the Target-Object-Centered Mixed Reality Representation System

In the above configuration, the target-object-centered mixed reality representation system 100 projects the virtual environment's CG image V1, which is associated with the real environment's target object 105 that was actually moved by the user 106, onto the screen 104. Accordingly, the real environment's target object 105 overlaps with the virtual environment's CG image V1 on the screen 104.

In that manner, the target-object-centered mixed reality representation system 100 projects onto the screen 104 the virtual environment's CG image V1, which changes in the accordance with the motion of the real environment's target object 105. Accordingly, with the virtual object model such as a background image, which moves according to the change of two-dimensional position of the real environment's target object 105, or a laser beam, which is added according to the three-dimensional attitude (motion) of the real environment's target object 105, a pseudo three-dimensional space is provided by combining the real environment's target object 105 and the virtual environment's CG image V1 on the same space.

Accordingly, when the user 106 radio-controls the real environment's target object 105 on the screen 104, he/she watches the background image, which is changing according to the motion of the real environment's target object 105, and the added virtual object model. This gives the user 106 a more vivid sense of three-dimensional mixed reality than the MR (Mixed Reality) technique that uses only two-dimensional images does.

In addition, the target-object-centered mixed reality representation system 100 places the real environment's object 105 on the virtual environment's CG image V1 in which a background image and a virtual object model are associated with the actual motion of the real environments target object 105. This can realize communication between the real environment and the virtual environment, more entertaining than ever before.

According to the above configuration, the target-object-centered mixed reality representation system 100 combines on the screen 104 the real environment's target object 105 and the virtual environment's CG image V1 that changes according to the actual movement of the real environment's target object 105, realizing on the screen 104 a pseudo three-dimensional space in which the real environment blends in with the virtual environment. The user 106 therefore can feel a more vivid sense of mixed reality than ever before through the pseudo three-dimensional space.

### (2-2) Overall Configuration of the Virtual-Object-Model-Centered Mixed reality Representation System

In FIG. 13 whose parts have been designated by the same symbols as the corresponding parts of FIG. 9, the reference numeral 200 denotes a virtual-object-model-centered mixed reality representation system, in which the virtual environment's CG image V2 supplied from the computer device 102 is projected from the projector 103 onto the screen 104.

On the screen 104 where the virtual environment's CG image V2 has been projected, the real environment's target object 105, which is indirectly remote-controlled by the user 106 through an input section 127, is placed This places the real environment's target object 105 on the CG image V2 on the screen 104.

In the virtual-object-model-centered mixed reality representation system 200, the configuration of the computer device 102 is the same as that of the computer device 102 (FIG. 109 of the target-object-centered mixed reality representation system 100. Therefore, that configuration is not described here. In addition, the CPU 121 is designed to execute a basic program and a mixed reality representation program and perform a predetermined process to realize the virtual space buildup section 109 as a software component, in the same way as the computer device 102 of the target-object-centered mixed reality representation system 100 does.

The virtual-object-model-centered mixed reality representation system 200 indirectly moves the real environment's target object 105 through a virtual environment's target object model corresponding to the real environment's target object 105, which is different from the target-object-centered mixed reality representation system 100 in which the user 106 directly moves the real environment's target object 105.

That is, in the virtual-object-model-centered mixed reality representation system 200, the virtual environment's target object model corresponding to the real environment's target object 105 can virtually move in the world of the computer device 102 as the user 106 manipulates the input section 127. A command signal S12 for moving the target object model is supplied to the virtual space buildup section 109 as change information regarding the target object model.

That is, in the computer device 102, the physical calculation section 113 of the virtual space buildup section 109 moves the virtual environment's target object model in accordance with the command signal S12 from the user 106. In this case, the computer device 102 moves a background image, in accordance with the motion of the virtual environment's target object model, and also generates a virtual object to be added. Data D1, such as the background image, which has been changed according to the motion of the virtual environment's target object model, and the virtual object model, which is to be added to the virtual environment's target object model, are supplied to the video signal generation section 114.

At the same time, the physical calculation section 113 of the virtual space buildup section 109 supplies a control signal S14, which was generated according to the position and motion of the target object model moving in the virtual environment, to the real environment's target object 105, which then moves with the virtual environment's target object model.

In addition, the video signal generation section 114 generates a CG video signal S13 based on the data D1 including the background image, virtual object model and the like, and then projects, in accordance with the CG video signal S13, the virtual environment's CG image V2 from the projector 103 onto the screen 104. This can change the background image in accordance with the real environment's target object 105 that is moving with the virtual environment's target object model, and also add the virtual object model, enabling a user to feel a sense of mixed reality through a pseudo three-dimensional space in which the real environment's target object 105 blends in with the virtual environment's CG image V2.

By the way, in order to prevent a part of the virtual environment's CG image V2 from being projected on the surface of the real environment's target object 105 when the virtual environment's image V2 is projected on the screen 104, this video signal generation section 114 too cuts off, in accordance with the position and size of the virtual environment's target object model corresponding to the real environment's target object 105, a part of the image equivalent to the target object model and generates a CG video signal S13 such that a shadow is added to around the target object model.

By the way, the virtual-object-model-centered mixed reality representation system 200 can provide a pseudo three-dimensional space generated by combining the virtual environment's CG image V2 projected from the projector 103 onto the screen 104 and the real environment's target object 105 to all the users 106 who can see the screen 104 with the naked eye. Like the target-object-centered mixed reality representation system 100, the virtual-object-model-centered mixed reality representation system 200 may be categorized as the so-called optical see-through type, in which light reach the user 106 directly from the outside.

(2-2-1) Sequence of a Virtual-Object-Model-Centered Mixed reality Representation Process

Following describes a sequence of a virtual-object-model-centered mixed reality representation process by which thereat environment's target object 105 in the virtual-object-model-centered mixed reality representation system 200 is moved in conjunction with the movement of the virtual environment's target object model.

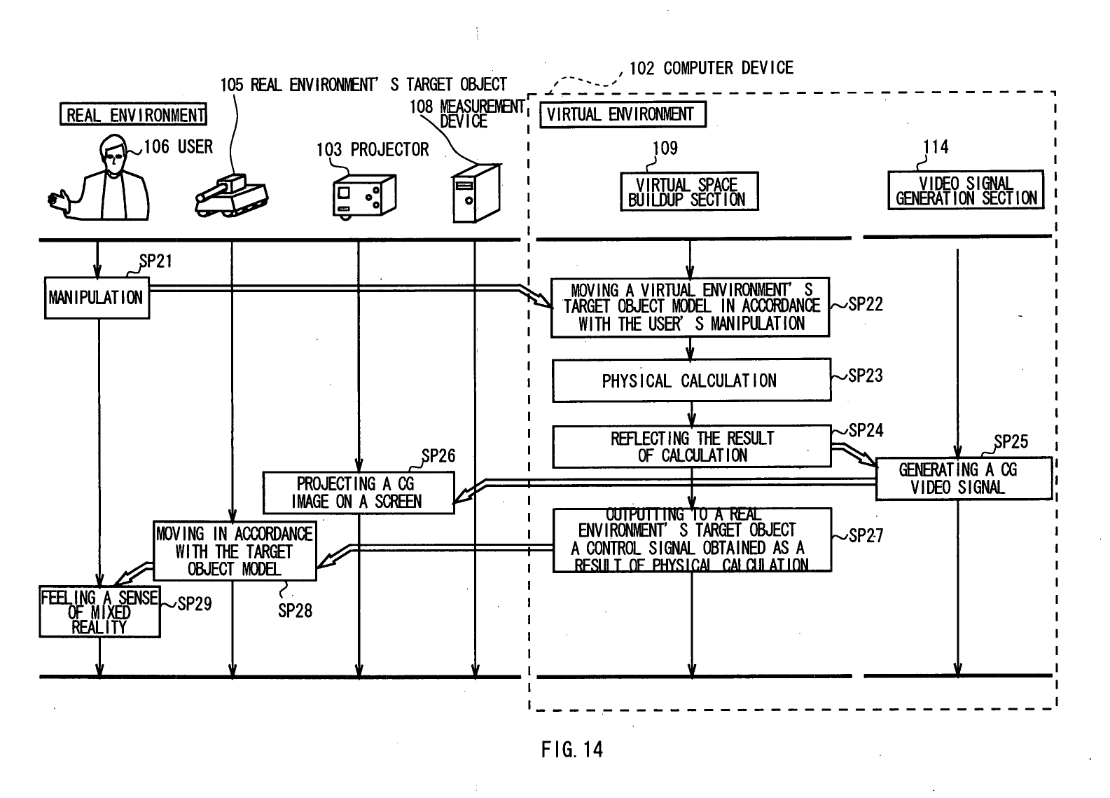

As shown in FIG. 14, the sequence of the virtual-object-model-centered mixed reality representation process can be divided into a process flow for the real environment, and a process flow for the virtual environment controlled by the computer device 102. The results of each process are combined on the screen 104.

Specifically, the user 106 at step SP21 manipulates the input section 127 of the computer device 102 and then proceeds to next step SP22. In this case, the command the user 106 inputs is for moving or operating the target object model in the virtual environment created by the computer device 102, instead of the real environment's target object 105.

The virtual space buildup section 109 at step SP22 moves the virtual environment's target object model generated by the virtual object model generation section 111, in accordance with how the input section 127 of the computer device 102 is manipulated for input.

The virtual space buildup section 109 at step SP23, controls the physical calculation section 113 to calculate the data D1 including a background image, which moves according to the motion of the virtual environment's target object model, and a virtual object model to be added to the target object model. In addition, the virtual space buildup section 109 generates the control signal S14 (FIG. 13) to actually move on the screen 104 the real environment's target object 105 in accordance with the motion of the virtual environment's target object model.

Subsequently, the virtual space buildup section 109 at step SP24 performs a signal process to the data D1, or the result of calculation by the physical calculation section 113, and the control signal S14, in order for the data D1 and the control signal S14 to be reflected in the virtual environment's CG image V1.

As a result of the reflection process, the video signal generation section 114 at step SP25 produces the CG video signal S13 such that it is associated with the motion of the virtual environment's target object model and then outputs the CG video signal S13 to the projector 103.

The projector 103 at step SP26 projects, in accordance with the CG video signal S13, the CG image V2, which is like the CG image V1 in FIG. 12, on the screen 104.

The virtual space buildup section 109 at step SP27 supplies the control signal S14 calculated at step SP23 by the physical calculation section 113 to the real environment's target object 105. The real environment's target object 105 at step SP28 moves on the screen 104 or changes its attitude (motion), in accordance with the control signal S14 supplied from the virtual space buildup section 109, expressing what the user 106 intends to do.

Accordingly, even in the virtual-object-model-centered mixed reality representation system 200, by supplying to the real environment's target object 105 the control signal S14 that was generated by the physical calculation section 113 in accordance with the position and motion of the virtual environment's target object model, the real environment's target object 105 moves according to the motion of the virtual environment target object model. In addition, thereat environment's target object 105 overlaps with the virtual environment's CG image V2 that changes according to the motion of the virtual environment's target object model. Accordingly, like the target-object-centered mixed reality representation system 100, a pseudo three-dimensional space can be built as shown in FIG. 12.

In this case, that prevents a part of the virtual environment's CG-image V2 from being projected on the surface of the real environment's target object 105 when the virtual environment's CG image V2 is projected on the screen 104. At the same time, a shadow image is added to around the real environment's target object 105. This presents a pseudo three-dimensional space with a more vivid sense of reality by combining the real environment's target object 105 with the virtual environment's CG image V2.

Accordingly, the user 106 at step SP29 watches the pseudo three-dimensional space, in which the real environment's target object 105 blends in with the virtual environment's CG image V2, on the screen 104 and therefore can feel a more vivid sense of mixed reality with the more expanded functions.

(2-2-2) Operation and Effect in the Virtual-Object-Model-Centered Mixed reality Representation System

In the above configuration, the virtual-object-model-centered mixed reality representation system 200 projects onto the screen 104 the virtual environment's CG image V2, which changes according to the motion of: the virtual environment's target object model moved by the user 106. At the same time, the virtual-object-model-centered mixed reality representation system 200 can actually move the real environment's target object 105 in accordance with the movement of the virtual environment's target object model.

In this manner, in the virtual-object-model-centered mixed reality representation system 200, the real environment's target object 105 and the virtual environment's CG image V2 change as the user moves the virtual environment's target object model corresponding to the real environment's target object 105. This presents a pseudo three-dimensional space in which the real environment's target object 105 blends in with the virtual environment's CG image V2 on the same space.

Accordingly, the user 106 can move the real environment's target object 105 by controlling, through the input section 127, the virtual environment's target object model, without operating the real environment's target object 105 directly. At the same time, the user 106 can see the CG video image V2 that changes according to the movement of the virtual environment's target object model. This gives a more vivid sense of three-dimensional mixed reality than the MR technique that only uses two-dimensional images does.

In addition, the virtual-object-model-centered mixed reality representation system 200 actually moves the real environment's target object 105 in accordance with the motion of the virtual environment's target object model. At the same time, the real environment's target object 105 is placed on the virtual environment's CG image V2 in which a background image and a virtual object model are changing according to the motion of the virtual environment's target object model. This can realize communication between the real environment and the virtual environment, more entertaining than ever before.

According to the above configuration, the virtual-object-model-centered mixed reality representation system 200 indirectly moves, through the virtual environment's target object model, the real environment's target object 105 and combines on the screen 104 the real environment's target object 105 with the virtual environment's CG image V2 that changes with the movement of the real-environment's target object 105. This presents a pseudo three-dimensional space on the screen 104, in which the real environment blends in with the virtual environment. This pseudo three-dimensional space gives the user 106 a more vivid sense of mixed reality than ever before.

### (2-3) Application Areas

By the way, the above describes an example in which the target-object-centered mixed reality representation system 100 and the virtual-object-model-centered mixed reality representation system 200 are applied to a gaming device that regards a model combat vehicle or the like as the real environment's target object 105. In addition, they can be applied to other things.

### (2-3-1) Application to an Urban Disaster Simulator

Specifically, the target-object-centered mixed reality representation system 100 and the virtual-object-model-centered mixed reality representation system 200 can be applied to an urban disaster simulator by, for example, regarding the models of building or the like in a city as real environment's target object 105, generating a background image of the city by the background image generation section 112 of the virtual space buildup section 109, adding the virtual object models, such as a fire caused by a disaster, created by the virtual object model generation section 111, and then projecting the virtual environment's CG image V1 or V2 on the screen 104.

Especially, in this case, in the target-object-centered mixed reality representation system 100 and the virtual-object-model-centered-mixed reality-representation-system 200, the measurement device 108 is embedded in the real environment's target object 105 or the model of building. By manipulating the radio controller 107, an eccentric motor embedded in the model of building is driven to swing, move or collapse the model of building, simulating for example an earthquake. In this case, the virtual environment's CG image V1 or V2, which changes according to the motion of the real environment's target object, is projected, presenting the state of an earthquake, a fire and the collapse of building.

Based on the result of simulation, the computer device 102 calculates the force of earthquake and the structural strength of building and predicts the spread of fire. Subsequently, while the result is reflected in the virtual environment's CG image V1, the control signal S14 is supplied, as feedback, to the real environment's target object 105 or the model of building in order to move the real environment's target object 105 again. This provides the user 106 with a visual pseudo three-dimensional space in which the real environment blends in with the virtual environment.

### (2-3-2) Application to a Music Dance Game

In addition, the target-object-centered mixed reality representation system 100 and the virtual-object-model-centered mixed reality-representation system 200 can be applied to a music dance game device, in which a person enjoys dancing, by, for example, regarding a person as the real environment's target object 105, using a large screen display laid out on a floor of a disco, a club or the like, on which the virtual environment's CG image V1 or v2 is displayed, detecting in real time the motion of the person dancing on the large screen display through a pressure sensing device-attached to the surface of the display such as a touch panel or the like that use transparent electrodes, supplying the motion information S1 to the virtual space buildup section 109 of the computer device 102, and displaying the virtual environment's CG image V1 or V2 that changes in real time in accordance with the motion of the person.

The pseudo three-dimensional space, provided by the virtual environment's CG image V1 or V2 that changes according to the motion of the person, gives the user 106 a more vivid sense of reality like he/she is really dancing in the virtual environment's image V1 or V2.

By the way, the user 106 may be asked to choose his/her favorite color or character. The virtual space buildup section 109 may generate and display the virtual environments CG image V1 or V2 in which the character dances too, like the shadow of the user 106, as the user 106 dances. The content of the virtual environment's CG image V1 or V2 may be determined based on the result of selection by the user 106 who selects his/her favorite items such as blood type, age or zodiac sign. There are wide variations.

### (2-4) Alternate Embodiment

In the above-noted target-object-centered mixed reality representation system 100 and the virtual-object-model-centered mixed reality representation system 200, the real environment's target object 105 is a model of combat vehicle. However, the present invention is not limited to this. The real environment's target object 105 could be a person or animal. In this case, a pseudo three-dimensional space or a sense of mixed reality is provided by changing the virtual environment's CG image V1 or V2 on the screen 104 in accordance with the motion of the person or animal.

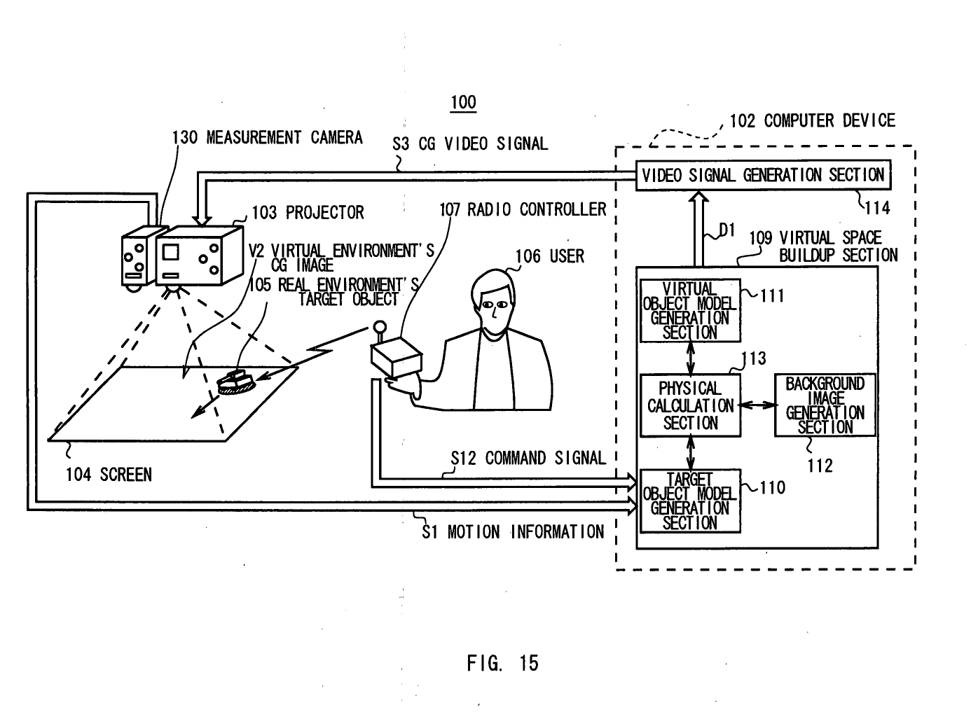

Moreover, in the above-noted target-object-centered mixed reality representation system 100 and the virtual-object-model-centered mixed reality representation system 200, the magnetic- or optical-type measurement device 108 detects the two-dimensional position or three-dimensional attitude (motion) of the real environment's target object 105 as the motion information S1 and then supplies the motion information S1 to the virtual space buildup section 109 of the computer device 102. However, the present invention is not limited to this. As shown in FIG. 15 whose parts have been designated by the same symbols as the corresponding parts of FIG. 15, instead of using the magnetic- or optical-type measurement device 108, it may use a measurement camera 130 that sequentially takes pictures of the real environment's target object 105 on the screen 104 at predetermined intervals; comparing the two successive images gives the motion information S1 such as the two-dimensional position and attitude (motion) of the real environment's target object 105 on the screen 104.

Furthermore, in the above-noted target-object-centered mixed reality representation system 100 and the virtual-object-model-centered mixed reality representation system 200, the magnetic- or optical-type measurement device 108 detects the two-dimensional position or three-dimensional attitude (motion) of the real environments target object 105 as the motion information S1 and then supplies the motion information S1 to the virtual space buildup section 109 of the computer device 102. However, the present invention is not limited to this. For example, instead of the screen 104, a display displays the virtual environment's CG images V1 and V2 based on the CG video signals S3 and S13; the real environment's target object 105 is placed on them; the motion information S1 that indicates the change of motion of the real environment's target object 105 is acquired in real time through a pressure sensing device attached to the surface of the display, such as a touch panel or the like that use transparent electrodes; and the motion information S1 is supplied to the virtual space buildup section 109 of the computer device 102.

Furthermore, in the above-noted target-object-centered mixed reality representation system 100 and the virtual-object-model-centered mixed reality representation system 200, the screen 104 is used. However, the present invention is not limited to this. Various display means may be used, such as CRT (Cathode Ray Tube Display), LCD (Liquid Crystal Display), a large screen display such as Jumbo Tron (Registered Trademark) that is a collection of displaying elements.

Furthermore, in the above-noted target-object-centered mixed reality representation system 100 and the virtual-object-model-centered mixed-reality representation system 200, the projector 103 above the screen 104 projects the virtual environment's CG images V1 and V2 on the screen 104. However, the present invention is not limited to this. The projector 103 may be located under the screen 104, projecting the virtual environment's CG images V1 and V2 on the screen 104. Alternatively, the virtual environment's CG images V1 and V2 may be projected as virtual images, through a half mirror, on the front or back face of the real environment's target object 105.

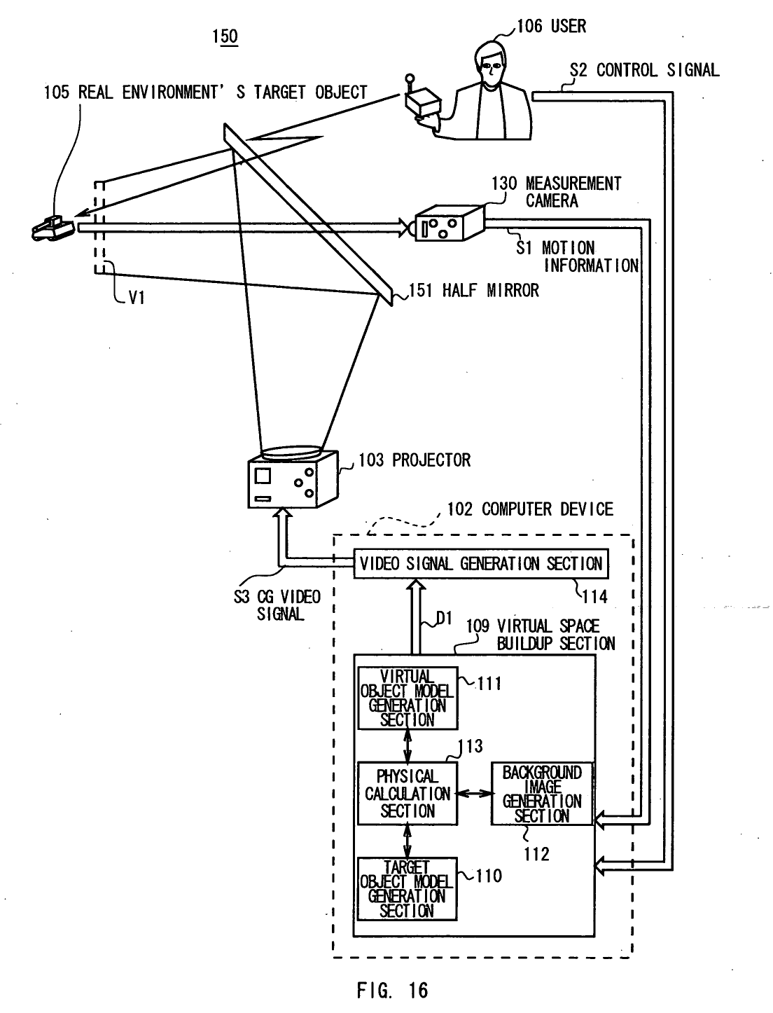

Specifically, as shown in FIG. 16 whose parts have been designated by the same symbols as the corresponding parts of FIG. 9, in the target-object-centered mixed reality representation system 150, the virtual environment's CG image V1 that the video signal generation section 114 of the computer device 102 outputs in accordance with the CG video signal S3 is projected as virtual image on the front or back face (not shown) of the real environment's target object 105 through a half mirror 115. The motion information S1, which was acquired by the measurement camera 130 that detects through a half mirror 151 the motion of the real environment's target object 105, is supplied to the virtual space buildup section 109 of the computer device 102.

Accordingly, in the target-object-centered mixed reality representation system 150, the virtual space buildup section 109 generates the CG video signal S3 that changes according to the motion of the real environment's target object 105. Based on the CG video signal S3, the virtual environment CG image V1 is projected on the real environment's target object 105 through the projector 103 and the half mirror 151. This presents a pseudo three-dimensional space in which the real environment's target, object 105 blends in with the virtual environment's CG image V1 on the same space, enabling the user 106 to feel a more vivid sense of mixed reality.

Furthermore, in the above-noted virtual-object-model-centered mixed reality representation system 200, the user 106 manipulates the input section 127 to indirectly move the real environment's target object 105 through the virtual environment's target object model. However, the present invention is not limited to this. Instead of moving the real environment's target object 105 through the virtual environment's target object model, for example, the real environment's target object 105 is placed on the display 125; the input section 127 is manipulated to display on the display 125 instruction information in order to move the real environment's target object 105; the instruction information follows the real environment's target object 105 in order to move the real environment's target object 105.

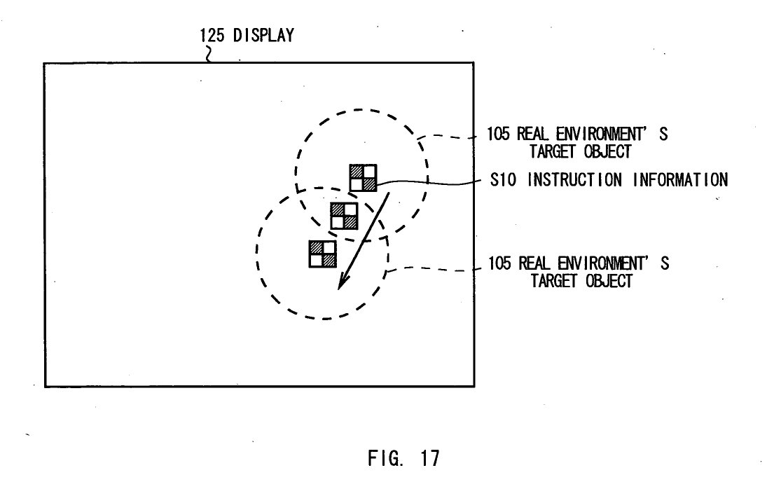

Specifically, as shown in FIG. 17, beneath the real environment's target object 105 on the display 125, the instruction information S10 including four pixels of checked pattern, which is irrelevant to the design of the virtual environment's CG image V2 displayed by the computer device 102, is displayed and moved in a direction of an arrow at predetermined intervals in accordance with a command from the input-section 127.

The real environment's target object 105 includes a sensor that is attached to the under surface of the target object 105 and can detect the instruction information S1 that moves on the display 125 at predetermined intervals. The sensor detects the instruction information S10 on the display 125 as change information and forces the instruction information S10 to follow.

Accordingly, instead of indirectly moving the real environment's target object 105 through the virtual environment's target object model, the computer device 102 can move the real environment's target object 105 by specifying the instruction information S10 on the display 125.

Furthermore, in the above-noted virtual-object-model-centered mixed reality representation system 200, the command signal S12, which was generated as a result of manipulating the input section 127, is output to the virtual space buildup section 109 in order to indirectly move the real environment's target object 105 through the virtual environment's target object model. However, the present invention is not limited to this. A camera may take a picture of the virtual environment's CG image V2 projected on the screen 104 and, based on the result of taking the picture, the control signal S14 may be supplied to the real environment's target object 105. This moves the real environment's target object 105 in conjunction with the virtual environment's CG image V2.

Furthermore, in the above-noted target-object-centered mixed reality representation system 100 and the virtual-object-model-centered mixed reality representation system 200, as state-recognition that is the result of recognizing the state of the real environment's target object 105, the motion information S1 that indicates the two-dimensional position and three-dimensional attitude (motion) of the real environment's target object 105 is acquired. However, the present invention is not limited to this. For example, if the real environment's target object 105 is a robot, how its facial expression changes may be acquired as state recognition, in accordance with which the virtual environment's CG image V1 changes.

Furthermore, in the above-noted target-object-centered mixed reality representation system 100 and the virtual-object-model-centered mixed reality representation system 200, the virtual environment's CG images V1 and V2 are generated such that, in accordance with the actual motion of the real environment's target object 105, a background image changes and a virtual object model is added. However, the present invention is not limited to this. The virtual environment's CG images V1 and V2 may be generated such that, in accordance with the actual motion of the real environment's target object 105, only a background image changes, or a virtual object model is added.

Furthermore, in the above-noted target-object-centered mixed reality representation system 100 and the virtual-object-model-centered mixed reality representation system 200, the correlation between the real environment's target object 105 remote-controlled by the user 106 and the virtual environment's CG images V1 and V2 was described. However, the present invention is not limited to this. As for a correlation between the real environment's target object 105 the user 106 owns and the real environment's target object 105 another user owns, a sensor is provided to detect a collision when they collide with each other; when it detects a collision, the control signal S14 is output to the real environment's target object 105 in order to vibrate the real environment's target object 105 or change the virtual environment's CG images V1 and V2.

Furthermore, in the above-noted target-object-centered mixed reality representation system 100, the virtual environment's CG image V1 changes according to the motion information S1 about the real environment's target object 105. However, the present invention is not limited to this. It may be detected whether a removable component is attached to or removed from the real environment's target object 105 and then changes, in accordance with the result of detection, the virtual environment's CG image V1.

### (3) The Detailed Mixed reality Providing System to Which the Position tracking Principle Is Applied

The above describes a basic concept for providing a sense of three-dimensional mixed reality, in which the target-object-centered mixed reality representation system 100 and the virtual-object-model-centered mixed reality representation system 200 present a pseudo three-dimensional space where the real environment's target object 105 blends in with the virtual environment's CG images V1 and V2 on the same space. Following describes two types of mixed reality providing system in detail, to which the basic concept of the position detection principle (1) is applied.

### (3-1) An Upper-Surface-Radiation-Type Mixed Reality Providing System

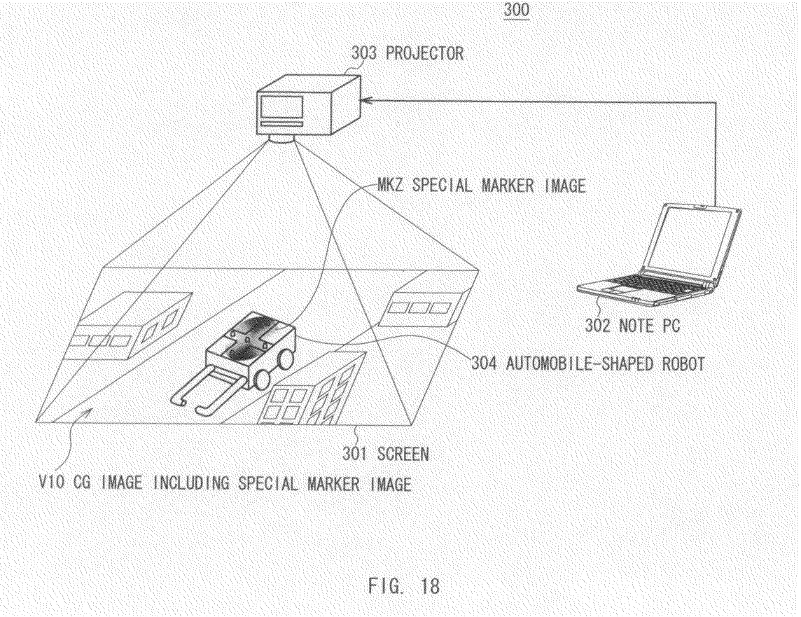

As shown in FIG. 18, in an upper-surface-radiation-type mixed reality providing system 300, a CG image V10 including a special marker image, which was generated by a note PC 302, is projected through a projector 302 onto a screen 301 where an automobile-shaped robot 304 is placed.

As shown in FIG. 19, the above-noted-special marker image MKZ (FIG. 7) is placed at substantially the center of the CG image V10 including the special marker image. Around the special marker image MKZ is a background image such as buildings. If the automobile-shaped robot 304 is placed on substantially the center of the screen 301, the special marker image MKZ is projected on the back, or upper surface, of the automobile-shaped robot 304.

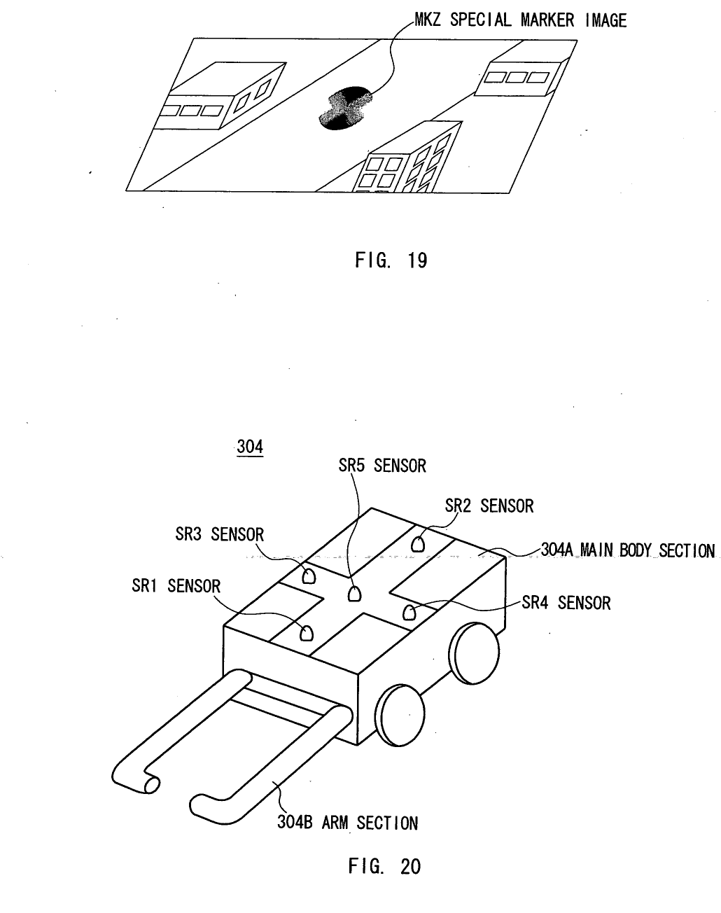

As shown in FIG. 20, the automobile-shaped robot 304 includes, like the automobile-shaped robot 3 (FIG. 2), four wheels on the left and right sides of a main body section 304A that is substantially in the shape of a rectangular parallelepiped. The automobile-shaped robot 304 also includes an arm section 304B on the front side to grab an object. The automobile-shaped robot 304 moves on the screen 301 by following the special marker image MKZ projected on its back.

In addition, the automobile-shaped robot 304 includes five sensors, or phototransistors, SR1 to SR5 on the predetermined positions of the back of the robot 304. The sensors SR1 to SR5 are associated with the special marker image MKZ of the CG image V10 including the special marker image. The sensors SR1 and SR2 are placed on the front and rear sides of the main body section 304A, respectively. The sensors SR3 and SR4 are placed on the left and right sides of the main body section 304A, respectively. The sensor SR5 is substantially placed on the center of the main body section 3A.

Accordingly, the automobile-shaped robot 304 in neutral state has, as shown in FIG. 7, its back's sensors SR1 to SR5 facing the centers of the position tracking areas PD1A, PD2A, PD3 and PD4 of the special marker image MKZ; each time when a frame or field of the CG image V10 including the special marker image is updated, the special marker image MKZ moves; the brightness levels of the sensors SR1 to SR4 therefore change as shown in FIGS. 8(A) and (B); and the change of relative position between the special marker image MKZ and the automobile-shaped robot 304 is calculated from the change of brightness levels.

Subsequently, the automobile-shaped robot 304 calculates where the automobile-shaped robot 304 should head for and its coordinates, which make the change of relative position between the special marker image MKZ and the automobile-shaped robot 304 zero. In accordance with the result of calculation, the automobile-shaped robot 304 moves on the screen 301.

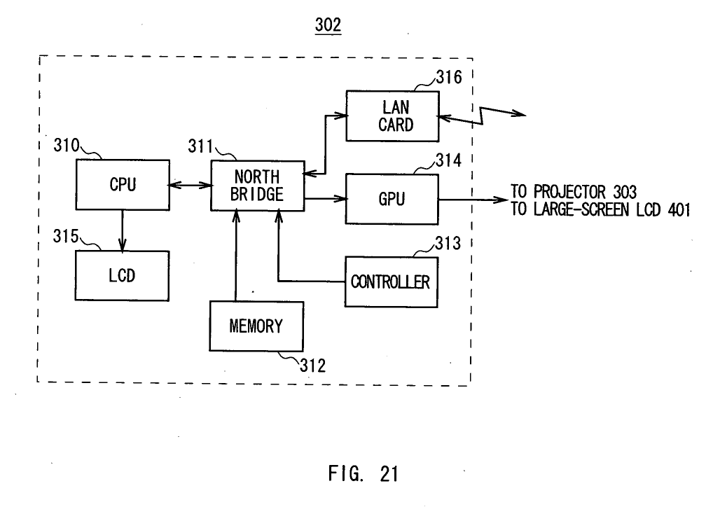

The note PC 302 includes, as shown in FIG. 21, a CPU (Central Processing Unit) 310 that takes overall control. A GPU (Graphical Processing Unit) 314 generates the above CG image V10 including the special marker image in accordance with a basic program and a mixed reality providing program and other application programs, which were read out from a memory 312 via a north bridge 311.

The CPU 310 of the note PC 302 accepts user's manipulation from a controller 313 via the note bridge 311. If the manipulation instructs the direction and distance the special marker image MKZ will move, the CPU 310 supplies, in accordance with the manipulation, to the GPU 314 a command that instructs to generate a CG image V10 including the special marker image MKZ that has been moved a predetermined distance from the center of the screen in a predetermined direction.

Even when the CPU 310 of the note PC 302 reads out, during a certain sequence, a program representing the direction and distance the special marker image MKZ will move, other than a case in which the CPU 310 accepts user's manipulation from the controller 313, the CPU 310 supplies to the GPU 314 a command that instructs to generate a CG image V10 including the special marker image MKZ that has been moved a predetermined distance from the center of the screen in a predetermined direction.

The GPU 314 generates, in accordance with the command from the CPU 310, a CG image V10 including the special marker image MKZ that has been moved a predetermined distance from the center of the screen in a predetermined direction, and then supplies it to the projector 303, which then projects it on the screen 301.

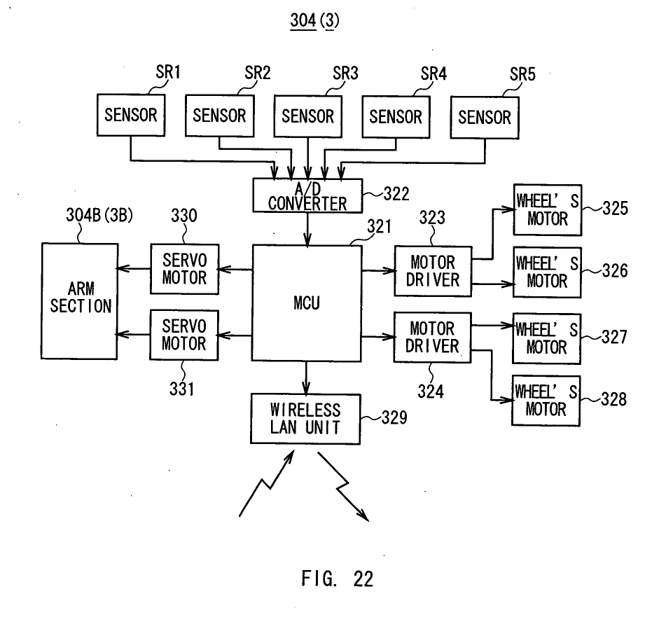

On the other hand, as shown in FIG. 22, the automobile-shaped robot 304 always follows the sampling frequency of the sensors SR1 to SR5 and detects, through its back's sensors SR1 to SR5, the brightness levels of the special marker image MKZ and then supplies the resultant brightness level information to an analog-to-digital conversion circuit 322.

The analog-to-digital conversion circuit 322 converts the analog brightness level information, supplied from the sensors SR1 to SR5, into digital brightness level data and then supplies it to a MCU (Micro Computer Unit) 321.

The MCU 321 can calculate an X-direction difference dx from the above equation (1), a Y-direction difference dy from the above equation (2) and a pivot angle dθ from the above equation (6). Accordingly, the MCU 321 generates a drive signal to make the differences dx and dy and the pivot angle dθ zero and transmits it to wheel's motor 325 to 328 via motor drivers 323 and 324. This rotates the four wheels, attached to the left and right sides of the main body section 304A, a predetermined amount in a predetermined direction.

By the way, the automobile-shaped robot 304 includes a wireless LAN (Local Area Network) unit 329, which wirelessly communicates with a LAN card 316 (FIG. 21) of the note PC 302. Accordingly, the automobile-shaped robot 304 can wirelessly transmit the X- and Y-direction differences dx and dy, which were calculated by the MCU 321, and the current position and direction (attitude), which are based on the pivot angle dθ, to the note PC 302 through the wireless LAN unit 329.

The note PC 302 (FIG. 21) displays on a LCD 315 the figures or two-dimensional coordinates of the current position, which were wirelessly transmitted from the automobile-shaped robot 304. The note PC 302 also displays on the LCD 315 an icon of a vector representing the direction (attitude) of the automobile-shaped robot 304. This allows a user to visually check whether the automobile-shaped robot 304 is precisely following the special marker image MKZ in accordance with the user's manipulation to the controller 313.

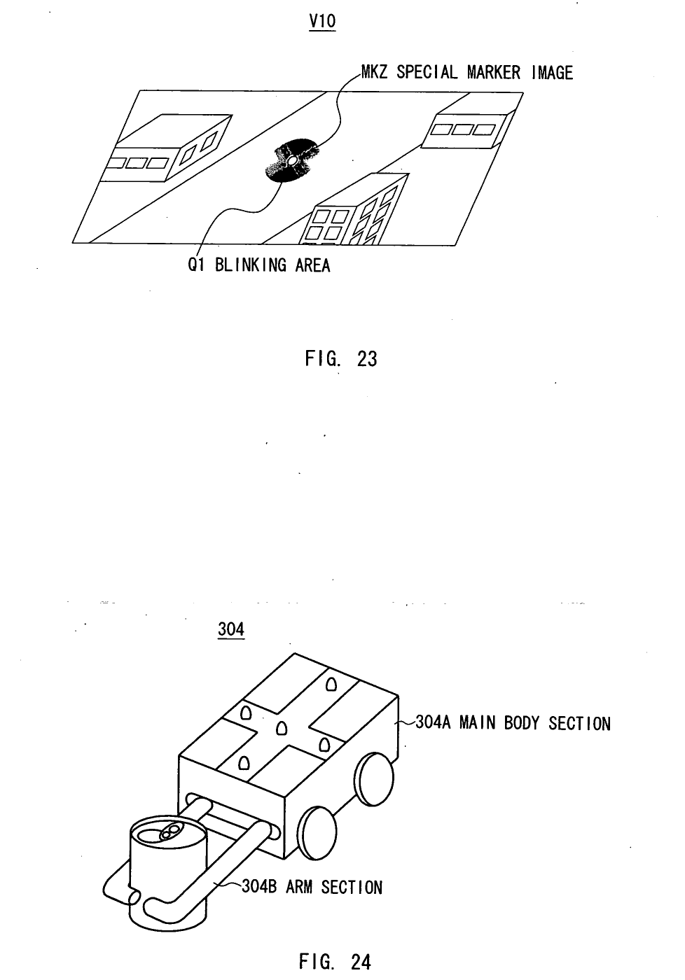

In addition, as shown in FIG. 23, the note PC 302 can project on the screen 301 a CG image CG in which there is a blinking area Q1 of a predetermined diameter on the center of the special marker image MKZ. The blinking area Q1 blinks at a predetermined frequency. Accordingly, a command input by a user from the controller 313 is optically transmitted to the automobile-shaped robot 304 as an optically-modulated signal.

At this time, the MCU 321 of the automobile-shaped robot 304 can detect, through the sensor SR5 on the back of the automobile-shaped robot 304, the change of brightness level of the blinking area Q1 of the special marker image MKZ of the CG image V10 including the special marker image. Based on the change of brightness level, the MCU 321 can recognize the command from the note PC 302.

If a command from the note PC 302 is instructing to move the arm section 304B of the automobile-shaped robot 304, the MCU 321 of the automobile-shaped robot 304 generates a motor control signal based on that command and drives servo motors 330 and 331 (FIG. 22), which then move the arm section 304B.

Actually, by operating the arm section 304B in accordance with a command from the note PC 302, the automobile-shaped robot 304 can hold, for example, a can in front of the robot 304 with the arm section 304B as shown in FIG. 24.

That is, the note PC 302 can indirectly control, through the special marker image MKZ of the CG image V10 including the special marker image, the automobile-shaped robot 304 on the screen 301 and can indirectly control, through the blinking area Q1 of the special marker image MKZ, the action of the automobile-shaped robot 304.

By the way, the CPU 310 of the note PC 302 wirelessly communicates with the automobile-shaped robot 304 through the LAN card 316. This allows the CPU 310 to control the movement and action of the automobile-shaped robot 304 directly without using the special marker image MKZ. In addition, by using the above position tracking principle, the CPU 310 can detect the current position of the automobile-shaped robot 304 on the screen 301.

Moreover, the note PC 302 recognizes the current position, which was wirelessly transmitted from the automobile-shaped robot 304, and also recognizes the content of the displayed CG image V10 including the special marker image. Accordingly, if the note PC 302 recognizes that there is a collision between an object, such as building, displayed as the CG image V10 including the special marker image and the automobile-shaped robot 304 on the coordinate of the screen 301, the note PC 302 stops the motion of the special marker image MKZ and supplies a command through the blinking area Q1 of the special marker image MKZ to the automobile-shaped robot 304 in order to vibrate the automobile-shaped robot 304.

Therefore, the MCU 321 of the automobile-shaped robot 304 stops as the special marker image MKZ stops. In addition, in accordance with the command supplied from the blinking area Q1 of the special marker image MKZ, the MCU 321 drives an internal motor to vibrate the main body section 304A. This gives a user an impression as if the automobile-shaped robot 304 was shocked by the collision with an object, such as building displayed on the CG image V10 including the special marker image. That presents a pseudo three-dimensional space in which the real environment's automobile-shaped robot 304 blends in with the virtual environment's CG image V10 including the special marker image on the same space.

As a result, instead of directly manipulating the real environment's automobile-shaped robot 304, a user can indirectly control the automobile-shaped robot 304 through the special marker image MKZ of the virtual environment's CG image V10 including the special marker image. At the same time, a user can have a more vivid sense of three-dimensional mixed reality in which the automobile-shaped robot 304 blends in with the content of the displayed CG image V10 including the special marker image in a pseudo manner.

By the way, in the upper-surface-radiation-type-mixed reality providing system 300, the projector 303 projects the special marker image MKZ of the CG image V10 including the special marker image onto the back of the automobile-shaped robot 304. Accordingly, if the automobile-shaped robot 304 is placed where the projector 303 is able to project the special marker image MKZ on the back of the automobile-shaped robot 304, the automobile-shaped robot 304 can move by following the special marker image MKZ. The automobile-shaped robot 304 therefore can be controlled on a floor or a road.

For example, if the upper-surface-radiation-type mixed reality providing system 300 uses a wall-mounted screen 301, the automobile-shaped robot 304 is placed on the wall-mounted screen 301 through a metal plate attached to the back of the wall-mounted screen 301 and a magnet attached to the bottom surface of the automobile-shaped robot 304. This automobile-shaped robot 304 can be indirectly controlled through the special marker image MKZ of the CG image V10 including the special marker image.

### (3-2) Lower-Surface-Radiation-Type Mixed reality Providing System

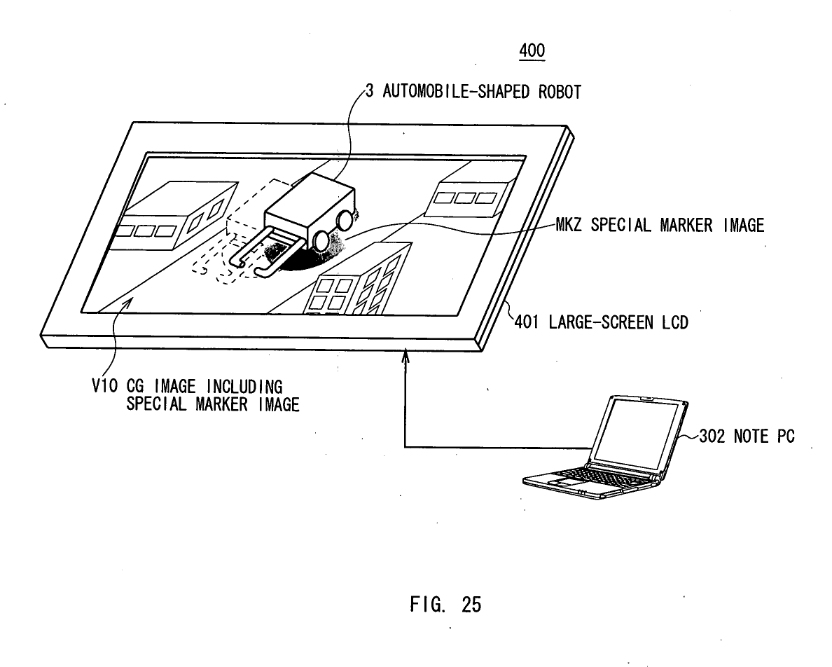

Unlike the above upper-surface-radiation-type mixed reality providing system 300 (FIG. 18), as shown in FIG. 25 whose parts have been designated by the same symbols as the corresponding parts of FIGS. 1 and 18, in a lower-surface-radiation-type mixed reality providing system 400, the CG image V10 including the special marker image, generated by the note PC 302, is displayed on a large-screen LCD 401 where the automobile-shaped robot 3 is placed.

As shown in FIG. 19, the above-noted special marker image MKZ is placed at substantially the center of the CG image V10 including the special marker image. Around the special marker image MKZ is a background image such as buildings. If the automobile-shaped robot 304 is placed on substantially the center of the large-screen LCD-401, the bottom of the automobile-shaped robot 3 faces the special marker image MKZ.

Since the configuration of the automobile-shaped robot 3 is the same as that of FIG. 2, it won't be described here. The automobile-shaped robot 3 in neutral state has its sensors SR1 to SR5 facing the centers of the position tracking areas PD1A, PD2A, PD3 and PD4 of the special marker image MKZ (FIG. 7) of the CG image V10 including the special marker image displayed on the large-screen LCD 401; each time when a frame or field of the CG image V10 including the special marker image is updated, the special marker image MKZ moves little by little; the brightness levels of the sensors SR1 to SR4 therefore change as shown in FIGS. 8(A) and (B); and the change of relative position between the special marker image MKZ and the automobile-shaped robot 3 is calculated from the change of brightness levels.

Subsequently, the automobile-shaped robot 3 calculates where the automobile-shaped robot 3 should head for and its coordinates, which make the change of relative position between the special marker image MKZ and the automobile-shaped robot 3 zero. In accordance with the result of calculation, the automobile-shaped robot 3 moves on the large-screen LCD 401.

The CPU 310 of the note PC 302 (FIG. 21) accepts user's manipulation from the controller 313 via the note bridge 311 and, if the manipulation instructs the direction and distance the special marker image MKZ will move, the CPU 310 supplies, in accordance with the manipulation, to the GPU 314 a command that instructs to generate a CG image V10 including the special marker image MKZ that has been moved a predetermined distance from the center of the screen in a predetermined direction.

Even when the CPU 310 of the note PC 302 reads out, during a certain sequence, a program representing the direction and distance the special marker image MKZ will move, other than a case in which the CPU 310 accepts user's manipulation from the controller 313, the CPU 310 supplies to the GPU 314 a command that instructs to generate a CG image V10 including the special marker image MKZ that has been moved a predetermined distance from the center of the screen in a predetermined direction.

The GPU 314 generates, in accordance with the command from the CPU 310, a CG image V10 including the special marker image MKZ that has been moved a predetermined distance from the center of the screen in a predetermined direction, and then displays it on the large-screen LCD 401.

On the other hand, the automobile-shaped robot 3 always follows the predetermined-sampling frequency and detects, through the sensors SR1 to SR5 on the bottom surface, the brightness levels of the special marker image MKZ and then supplies the resultant brightness level information to the analog-to-digital conversion circuit 322.

The analog-to-digital conversion circuit 322 converts the analog brightness level information, supplied from the sensors SR1 to SR5, into digital brightness level data and then supplies it to the MCU 321.

The MCU 321 can calculate an X-direction-difference dx from the above equation (1), a Y-direction difference-dy from the above equation (2) and a pivot angle dθ from the above equation (6). Accordingly, the MCU 321 generates a drive signal to make the differences dx and dy and the pivot angle dθ zero and transmits it to wheel's motor 325 to 328 via motor drivers 323 and 324. This rotates the four wheels, attached to the left and right sides of the main body section 3A, a predetermined amount in a predetermined direction.

This automobile-shaped robot 3, too, includes the wireless LAN unit 329, which wirelessly communicates with the note PC-302. Accordingly, the automobile-shaped robot 3 can wirelessly transmit the X- and Y-direction differences dx and dy, which were calculated by the MCU 321, and the current position and direction (attitude), which are based on the pivot angle dθ, to the note PC 302.

The note PC 302 (FIG. 21) therefore displays on the LCD 315 the figures or two-dimensional coordinates of the current position, which were wirelessly transmitted from the automobile-shaped robot 3. The note PC 302 also displays on the LCD 315 an icon of a vector representing the direction (attitude) of the automobile-shaped robot 3. This allows a user to visually check whether the automobile-shaped robot 3 is precisely following the special marker image MKZ in accordance with the user's manipulation to the controller 313.

In addition, as shown in FIG. 23, the note PC 302 can display on the large-screen LCD 401 a CG image CG in which there is a blinking area Q1 of a predetermined diameter on the center of the special marker image MKZ. The blinking area Q1 blinks at a predetermined frequency. Accordingly, a command input by a user from the controller 313 is optically transmitted to the automobile-shaped robot 3 as an optically-modulated signal.

At this time, the MCU 321 of the automobile-shaped robot 3 can detect, through the sensor SR5 on the bottom of the automobile-shaped robot 3, the change of brightness level of the blinking area Q1 of the special marker image MKZ of the CG image V10 including the special marker image. Based on the change of brightness level, the MCU 321 can recognize the command from the note PC 302.

If a command from the note PC 302 is instructing to move the arm section 3B of the automobile-shaped robot 3, the MCU 321 of the automobile-shaped robot 3 generates a motor control signal based on that command and drives the servo motors 330 and 331, which then move the arm section 3B.

Actually, by operating the arm section 3B in accordance with a command from the note PC 302, the automobile-shaped robot 3 can hold, for example, a can in front of the robot 3 with the arm section 3B.

That is, the note PC 302 can indirectly control, through the special marker image MKZ of the CG image V10 including the special marker image, the automobile-shaped robot 3 on the large-screen LCD 401 and can indirectly control, through the blinking area Q1 of the special marker image MKZ, the action of the automobile-shaped robot 3.

Moreover, the note PC 302 recognizes the current position, which was wirelessly transmitted from the automobile-shaped robot 3, and also recognizes the content of the displayed CG image V10 including the special marker image. Accordingly, if the note PC 302 recognizes that there is a collision between an object, such as building, displayed as the CG image V10 including the special marker image and the automobile-shaped robot 3 on the coordinate of the large-screen LCD 401, the note PC 302 stops the motion of the special marker image MKZ and supplies a command through the blinking area Q1 of the special marker image MKZ to the automobile-shaped robot 3 in order to vibrate the automobile-shaped robot 3.

Therefore, the MCU 321 of the automobile-shaped robot 3 stops as the special marker image MKZ stops. In addition, in accordance with the command supplied from the blinking area Q1 of the special marker image MKZ, the MCU 321 drives an internal motor to vibrate the main body section 3A. This gives a user an impression as if the automobile-shaped robot 3 was shocked by the collision with an object, such as building displayed on the CG image V10 including the special marker image. That presents a pseudo three-dimensional space in which the real environment's automobile-shaped robot 3 blends in with the virtual environment's CG image V10 including the special marker image on the same space.

As a result, instead of directly manipulating the real environment's automobile-shaped robot 3, a user can indirectly control the automobile-shaped robot 3 through the special marker image MKZ of the virtual environment's CG image V10 including the special marker image. At the same time, a user can have a more vivid sense of three-dimensional mixed reality in which the automobile-shaped robot 3 blends in with the content of the displayed CG image V10 including the special marker image in a pseudo manner.

By the way, in the lower-surface-radiation-type mixed reality-providing system 400, unlike the upper-surface-radiation-type mixed reality providing system 300, the CG image V10 including the special marker image is directly displayed on the large-screen LCD 401. In addition, the automobile-shaped robot 3 is placed such that its bottom faces the special marker image MKZ. This eliminates the influence of ambient light because the main body section 3A of the automobile-shaped robot 3 serves as a shield for the special marker image MKZ, enabling the automobile-shaped robot 3 to follow the special marker image MKZ accurately.

### (4) Operation and Effect in the Present Embodiment

In the above configuration, the note PC 1 (FIG. 1), as a position tracking device to which the above position tracking principle is applied, displays the basic marker image MK or special marker image MKZ such that it faces the automobile-shaped robot 3 on the screen of the liquid crystal display 2. Based on the change of brightness levels of the basic marker image MK or special marker-image MKZ, which was detected by the sensors SR1 to SR5 of the moving automobile-shaped robot 3, the note PC 1 can calculate the current position of the automobile-shaped robot 3.

At this time, the note PC 1 moves the displayed basic marker image MK or special marker image MKZ in order to return to neutral state, which is a state before the relative position between the current position of the automobile-shaped robot 3 that has moved and the basic marker image MK or special marker image MKZ has changed. Accordingly, the note PC 1 has the basic marker image MK or special marker image MKZ-following the moving automobile-shaped robot 3 and detects the current position of the automobile-shaped robot 3 moving on the screen of the liquid crystal display 2 in real time.

Especially, the note PC 1 uses the basic marker image MK or special marker image MKZ whose brightness level linearly changes from 0 to 100% to detect the position of the automobile-shaped robot 3. Therefore, the note PC 1 can precisely detect the current position of the automobile-shaped robot 3.

In addition, when using the special marker image MKZ (FIG. 7), the note PC 1 can more precisely detect the current position and attitude of the automobile-shaped robot 3 because, unlike the basic marker image MK (FIG. 3), the brightness levels around the boundaries between the position tracking areas PD1A, PD2A, PD3 and PD4 gradually change, which prevents the 100%-brightness-level light from leaking into the area of the 0%-brightness-level light.

In the upper-surface-radiation-type mixed reality providing system 300 and lower-surface-radiation-type mixed reality providing system 400 to which the position tracking principle is applied, the automobile-shaped robot 304 and the automobile-shaped robot 3 calculate in accordance with the position tracking principle. This allows the automobile-shaped robot 304 and the automobile-shaped robot 3 to follow the special marker image MKZ of the CG image V10 including the special marker image precisely.

Accordingly, in the upper-surface-radiation-type mixed reality providing system 300 and lower-surface-radiation-type mixed reality providing system 400, a user does not have to directly control the automobile-shaped robot 304 and the automobile-shaped robot 3. A user can indirectly move the automobile-shaped robot 304 and the automobile-shaped robot 3 by controlling, through the controller 313 of the note PC 302, the special marker image MKZ.

In this case, the CPU 310 of the note PC 302 can optically communicate with the automobile-shaped robot 304 and the automobile-shaped robot 3 through the blinking area Q1 of the special marker image MKZ. Accordingly, the CPU 310 can control the arm section 3B of the automobile-shaped robot 304 and automobile-shaped robot 3 and other parts through the blinking area Q1, as well as controlling the automobile-shaped robot 304 and the automobile-shaped robot 3 through the special marker image MKZ.

Particularly, the note PC 302 recognizes the current position, which was wirelessly transmitted from the automobile-shaped robot 304 and the automobile-shaped robot 3, and also recognizes the content of the displayed CG image V10 including the special marker image. Accordingly, if the note PC 302 recognizes, through the calculation of coordinates, that there is a collision between an object, which is displayed as the CG image V10 including the special marker image, and the automobile-shaped robots 304 and 3, the note PC 302 stops the motion of the special marker image MKZ in order to stop the automobile-shaped robot 304 and the automobile-shaped robot 3 and vibrates the automobile-shaped robot 304 and the automobile-shaped robot 3 through the blinking area Q1 of the special marker image MKZ. This gives a user a sense of mixed reality by combining the real environment's automobile-shaped robot 304 and automobile-shaped robot 3 and the virtual environment's CG image V10 including the special marker image on the same space.

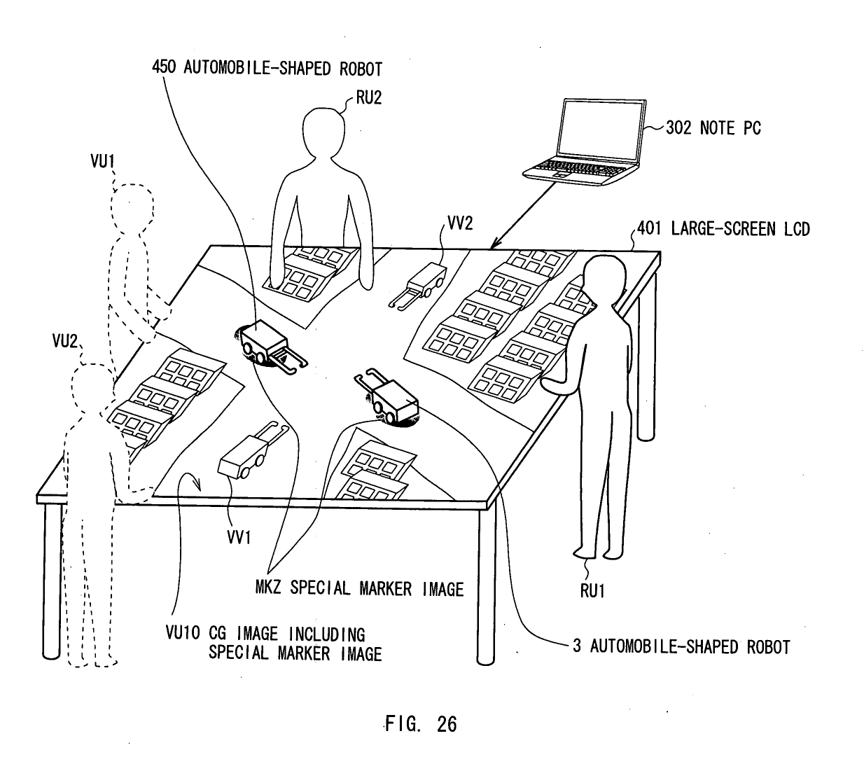

In reality, in the lower-surface-radiation-type mixed reality providing system 400, as shown in FIG. 26, if a user RU1 places his/her automobile-shaped robot 3 on the large-screen LCD 401 and a user RU2 places his/her automobile-shaped robot 450 on the large-screen LCD 401, each user RU1 and RU2 controls the special marker images MKZ of the CG image V10 including the special marker image by manipulating the note PC 302 in order to move the automobile-shaped robot 3 and the automobile-shaped robot 450 and fight against each other.

At this time, for example, the automobile-shaped robot images VU1 and VU2 that are remote-controlled by users VU1 and VU2 via the Internet are displayed on the CG image V10 including the special marker image on the screen of the large-screen LCD 401. The real environment's automobile-shaped robots 3 and 450 and the virtual environment's automobile-shaped robot images VU1 and VU2 fight against each other on the CG image V10 including the special marker image in a pseudo manner. If the automobile-shaped robot 3 collides with the automobile-shaped robot image VV1 on the screen, the automobile-shaped robot 3 vibrates to give a user a vivid sense of reality.

### (5) Other Embodiments

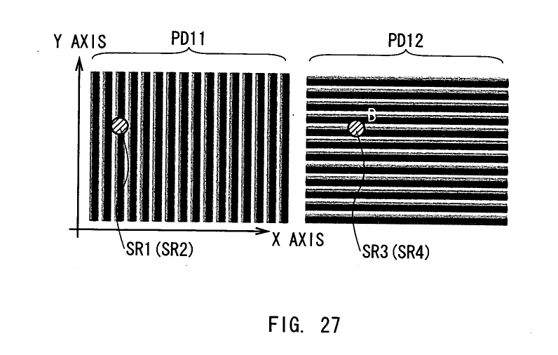

In the above-noted-embodiment, by using the basic marker image MK and the special marker image MKZ, the current position and attitude of the automobile-shaped robot 304 moving on the screen 301 and the automobile-shaped robot 3 moving on the screen of the liquid crystal display 2 or the large-screen LCD 401 are detected. However, the present invention is not limited to this. For example, as shown in FIG. 27, the marker images, each of which is a position tracking area PD11 including a plurality of vertical stripes whose brightness levels change linearly from 0 to 100%, may be displayed such that they face the sensors SR1 and SR2 of the automobile-shaped robot 3, while the marker images, each of which is a position tracking area PD12 including a plurality of horizontal stripes whose brightness levels change linearly from 0 to 100%, may be displayed such that they face the sensors SR3 and SR4 of the automobile-shaped robot 3; and the current position and attitude on the screen may be detected from the change of brightness levels of the sensors SR1 to SR4 and the number of vertical and horizontal stripes crossed.

Moreover, in the above-noted embodiment, by using the basic marker image MK or special marker image MKZ whose brightness levels gradually and linearly changes from 0 to 100%, the current position and attitude of the automobile-shaped robot 304 moving on the screen 301 and the automobile-shaped robot 3 moving on the screen of the liquid crystal display 2 or the large-screen LCD 401 are detected. However, the present invention is not limited to this. The current position and attitude of the automobile-shaped robot 3 may be detected from the change of hue of a marker image in which two colors (blue and yellow, for example) on opposite sides of the hue circle gradually change while the brightness level is maintained.

Furthermore, in the above-noted embodiment, the current position and attitude of the automobile-shaped robot 3 are calculated from the change of brightness level of the basic marker image MK or special marker image MKZ detected by the sensors SR1 to SR5 on the bottom of the automobile-shaped robot 3 placed on the screen of the liquid crystal display 2. However, the present invention is not limited to this. The projector 303 may project the basic marker image MK or special marker image MKZ on the top of the automobile-shaped robot 304; and the current position and attitude of the automobile-shaped robot 304 may be calculated from the change of brightness level detected by the sensors SR1 to SR5 of the automobile-shaped robot 304.

Furthermore, in the above-noted embodiment, the current position is detected by having the basic marker image MK or special marker image MKZ following the automobile-shaped robot 3 moving on the screen of the liquid crystal display 2. However, the present invention is not limited to this. For example, the top of a pen-type device may be placed on the special marker image MKZ on the screen; a plurality of sensors embedded in the top of the pen-type device may detect the change of brightness level when a user moves it on the screen as if tracing; and the pen-type device may wirelessly transmit it to the note PC 1, which then detect the current position of the pen-type device. In this case, if a character is traced by the pen-type device, the note PC 1 can recreate the character based on how it is traced.

Furthermore, in the above-noted embodiment, the note PC1 detects, in accordance with the position tracking program, the current position of the automobile shaped robot 3 while the note PC 302 indirectly controls, in accordance with the mixed reality providing program, the automobile-shaped robots 304 and 3. However, the present invention is not limited to this. By installing the position tracking program and the mixed reality providing program from storage media, such as CD-ROM (Compact Disc-Read-Only Memory), DVD-ROM (Digital Versatile Disc-Read only Memory) or a semiconductor memory, onto the note PC 1 or the note PC 302, the above current position tracking process and the indirect motion control process for the automobile-shaped robots 304 and 3 may be performed.

Furthermore, in the above-noted embodiment, the note PC1, note PC 302, and automobile-shaped robots 3 and 304, which constitute the position tracking device, includes the CPU 310 and the GPU 314, which are equivalent to an index image generation means that generates the basic marker image MK and the special marker image MKZ as an index image; the sensors SR1 to SR5, which are equivalent to a brightness level detection means; and the CPU 310, which is equivalent to a position detection means. However, the present invention is not limited to this. The above position tracking device may include other various circuit configurations or software configurations including the index image generation means, the brightness level detection means and the position detection means.

Furthermore, in the above-noted embodiment, the note PC 302, which is an information processing device that constitutes the mixed reality providing system, includes the CPU 310 and the GPU 314, which are equivalent to an index image generation means and an index image movement means, and the automobile-shaped robots 3 and 304, which are equivalent to a mobile object, include the sensors SR1 to SR5, which are equivalent to a brightness level detection means; the MCU 321, which is equivalent to a position detection means; and the MCU 321, the motor drivers 323 and 324 and the wheel motors 325 to 328, which are equivalent to a movement control means. However, the present invention is not limited to this. The above mixed reality providing system may consist of: an information processing device of the other circuit or software configuration including the index image generation means and the index image movement means; and a mobile object including the brightness level detection means, the position detection means and the movement control means.

### INDUSTRIAL APPLICABILITY

The position tracking device, position tracking method, position tracking program and mixed reality providing system of the present invention may be applied to various electronics devices that can combine the real environment's target object and the virtual environment's CG image, such as a stationary- or portable-type gaming device, a cell phone, PDA (Personal Digital Assistant) or a DVD (Digital Versatile Disc) player.

### DESCRIPTION OF SYMBOLS

1, 302 . . . NOTE PC, 2 . . . LIQUID CRYSTAL DISPLAY, 3, 304, 450 . . . AUTOMOBILE-SHAPED ROBOT, MK . . . BASIC MARKER IMAGE, MKZ . . . SPECIAL MARKER IMAGE, 100 . . . MIXED REALITY REPRESENTATION SYSTEM, 102 . . . COMPUTER DEVICE, 103 . . . PROJECTOR, 104, 301 . . . SCREEN, 105 . . . REAL ENVIRONMENT'S TARGET OBJECT, 106 . . . USER, 107 . . . RADIO CONTROLLER, 108 . . . MEASUREMENT DEVICE, 109 . . . VIRTUAL SPACE BUILDUP SECTION, 110 . . . TARGET OBJECT MODEL GENERATION SECTION, 111 . . . VIRTUAL OBJECT MODEL GENERATION SECTION, 112 . . . BACKGROUND IMAGE GENERATION SECTION, 113 . . . PHYSICAL CALCULATION SECTION, 114 . . . VIDEO SIGNAL GENERATION SECTION, 121, 310 . . . CPU, 122 . . . ROM, 123 . . . RAM, 124 . . . HARD DISK DRIVE, 125 . . . DISPLAY, 126 . . . INTERFACE, 127 . . . INPUT SECTION, 129 . . . BUS, 130 . . . MEASUREMENT CAMERA, 151 . . . HALF MIRROR, V1, V2, V10 . . . VIRTUAL ENVIRONMENT'S CG IMAGE, 300 . . . UPPER-SURFACE-RADIATION-TYPE MIXED REALITY PROVIDING SYSTEM, 311 . . . NORTH BRIDGE, 312 . . . MEMORY, 313 . . . CONTROLLER, 314 . . . GPU, 315 . . . LCD, 316 . . . LAN CARD, 321 . . . MCU, 322 . . . A/D CONVERSION CIRCUIT, 323, 324 . . . MOTOR DRIVER, 325-328 . . . WHEEL'S MOTOR, 330, 331 . . . SERVO MOTOR, 329 . . . WIRELESS LAN UNIT, 400 . . . LOWER-SURFACE-RADIATION-TYPE MIXED REALITY PROVIDING SYSTEM, 401 . . . LARGE-SCREEN LCD

1-14. (canceled)

15. A mixed reality representation device comprising:
a computer graphics image generation means for generating a virtual environment's computer graphics image to be displayed on a display means;
a state recognition means for recognizing the state of a real environment's target object that is placed such that the virtual environment's computer graphics image displayed on the display means and the real environment's target object overlap with one another; and
an interlocking means for displaying the virtual environment's computer graphics image in accordance with the state of the real environment's target object by changing, in accordance with the state of the real environment's target object recognized by the state recognition means, the virtual environment's computer graphics image.

16. The mixed reality representation device according to claim 15, wherein
the state recognition means including an image pickup means takes, by using the image pickup means, an image of position or motion of the real environment's target object and recognizes, based on a result of taking the image, the state of the real environment's target object.

17. The mixed reality representation device according to claim 15, wherein
the state recognition means includes:
an index image generation means for generating an index image including a plurality of areas whose brightness levels gradually change in first and second directions and displaying the index image on the display means such that the index image faces the real environment's target object;
a brightness level detection means provided on the real environment's target object for detecting the change of brightness level of the areas of the index image in the first and second directions; and
a position detection means for recognizing the state of the real environment's target object by detecting the position of the real environment's target object on the display means after calculating, based on the result of detection by the brightness level detection means, the change of relative coordinate value between the index image and the real environment's target object.

18. The mixed reality representation device according to claim 17, wherein
the position detection means detects, based on the brightness levels of the areas of the index image detected by the brightness level detection means in accordance with the real environment's target object movement on the display means, the position.

19. The mixed reality representation device according to claim 17, wherein
there is a brightness-level reference area on the index image, and the position tracking means detects, based on the brightness levels of the areas and reference area of the index image detected by the brightness level detection means in accordance with the real environment's target object movement on the display means, the position on the display means when the mobile object rotates.

20. The mixed reality representation device according to claim 17, wherein
the index image generation means generates the index image including the plurality of areas whose brightness levels gradually change in the first direction and the second direction perpendicular to the first direction and displays the index image on the display means such that the index image faces the real environment's target object.

21. The mixed reality representation device according to claim 17, wherein
the position detection means detects, based on the change of the number of the added brightness levels of the areas of the index image detected by the brightness level detection means in accordance with the real environment's target object movement on the display means, the height of the real environment's target object on the display means.

22. The mixed reality representation device according to claim 17, wherein
the index image generation means changes the brightness level linearly and gradually.

23. The mixed reality representation device according to claim 17, wherein
the index image generation means changes the brightness level nonlinearly and gradually.

24. The mixed reality representation device according to claim 15, comprising
a manipulation means for manipulating the real environment's target object, wherein
the state recognition means recognizes, in accordance with the manipulation of the manipulation means, the state of the real environment's target object.

25. The mixed reality representation device according to claim 15, wherein
the interlocking means generates, when the virtual environment's computer graphics image is being changed in accordance with the state recognized by the state recognition means, a predetermined virtual object model that is an image to be added in accordance with the state recognized by the state recognition means, and adds the virtual object model such that the virtual object model moves with the real environment's target object.

26. The mixed reality representation device according to claim 15, wherein
the computer graphics image generation means including a half mirror projects, by using the half mirror, the virtual environment's computer graphics image such that the real environment's target object placed at a predetermined position and the virtual environment's computer graphics image overlap with one another.

27. A mixed reality representation method for displaying a virtual environment's computer graphics image such that a real environment's target object and the virtual environment's computer graphics image overlap with one another, comprising:
a computer graphics image generation step of generating the virtual environment's computer graphics image to be displayed on a display means;
a display step of displaying on the display means the virtual environment's computer graphics image generated by the computer graphics image generation step;
a state recognition step of recognizing the state of a real environment's target object that is placed such that the virtual environment's computer graphics image displayed on the display means and the real environment's target object overlap with one another; and
an image interlocking step of displaying the virtual environment's computer graphics image in accordance with the state of the real environment's target object by changing, in accordance with the state of the real environment's target object recognized by the state recognition step, the virtual environment's computer graphics image.

28. The mixed reality representation method according to claim 27, wherein
the state recognition step includes:
an index image generation step of generating an index image including a plurality of areas whose brightness levels gradually change in first and second directions and displaying the index image on the display means such that the index image faces the real environment's target object;
a brightness level detection step of detecting, by using a brightness level detection means provided on the real environment's target object, the change of brightness level of the areas of the index image in the first and second directions; and
a position detection step of recognizing the state of the real environment's target object by detecting the position of the real environment's target object on the display means after a position detection means calculates, based on the result of detection by the brightness level detection step, the change of relative coordinate value between the index image and the real environment's target object.

29. A mixed reality representation device comprising:
a computer graphics image generation means for generating a virtual environment's computer graphics image to be displayed on a display means;
a computer graphics image change detection means for detecting the change of the virtual environment's computer graphics image displayed on the display means; and
an interlocking means for getting the real environment's target object to move with the virtual environment's computer graphics image by supplying an operation control signal to control the motion of the real environment's target object that is placed such that the virtual environment's computer graphics image and the real environment's target object overlap with one another, in accordance with the result of detection by the computer graphics image change detection means.

30. The mixed reality representation device according to claim 29, wherein
the computer graphics image change detection means including an image pickup means takes, by using the image pickup means, the computer graphics image, and supplies, based on a result of taking the image, the operation control signal to the real environment's target object.

31. The mixed reality representation device according to claim 29, wherein
the computer graphics image change detection means includes:
an index image generation means for generating an index image including a plurality of areas whose brightness levels gradually change in first and second directions and displaying the index image on the display means such that the index image faces the real environment's target object;
a brightness level detection means provided on the real environment's target object for detecting the change of brightness level of the areas of the index image in the first and second directions; and
a image change detection means for detecting the change of the virtual environment's computer graphics image by detecting the position of the real environment's target object on the display means after calculating, based on the result of detection by the brightness level detection means, the change of relative coordinate value between the index image and the real environment's target object.

32. The mixed reality representation device according to claim 29, wherein:
the computer graphics image change detection means includes a display control means to control the computer graphics image that the computer graphics image generation means generates; and
the operation control signal is supplied to the real environment's target object in accordance with a signal output from the display control means.

33. A mixed reality representation method for displaying a virtual environment's computer graphics image such that a real environment's target object and the virtual environment's computer graphics image overlap with one another, comprising:
a computer graphics image generation step of generating the virtual environment's computer graphics image to be displayed on a display means;
a display step of displaying on the display means the virtual environment's computer graphics image generated by the computer graphics image generation step;
a computer graphics image change detection step of detecting the change of the virtual environment's computer graphics image displayed on the display means; and
an image interlocking step of getting the real environment's target object to move with the virtual environment's computer graphics image by supplying an operation control signal to control the motion of the real environment's target object that is placed such that the virtual environment's computer graphics image and the real environment's target object overlap with one another, in accordance with the result of detection by the computer graphics image change detection step.

34. The mixed reality representation method according to claim 33, wherein
the computer graphics image change detection step includes:
an index image generation step of generating an index image including a plurality of areas whose brightness levels gradually change in first and second directions and displaying the index image on the display means such that the index image faces the real environment's target object;
a brightness level detection step of detecting, by using a brightness level detection means provided on the real environment's target object, the change of brightness level of the areas of the index image in the first and second directions; and
a image change detection step of detecting the change of the virtual environment's computer graphics image by detecting the position of the real environment's target object on the display means after a position detection means calculates, based on the result of detection by the brightness level detection step, the change of relative coordinate value between the index image and the real environment's target object.
